(19) United States
(12) Patent Application Publication
(10) Pub. No.: US 2016/0226073 A1
(43) Pub. Date: Aug. 4, 2016

(54) PtCu and PtNi Electrocatalysts Doped with Iodine

(71) Applicant: GEORGETOWN UNIVERSITY, Washington, DC (US)

(72) Inventors: YuYe J. Tong, Gaithersburg, MD (US); Honghui Wang, Xiamen (CN)

(73) Assignee: Georgetown University, Washington, DC (US)

(21) Appl. No.: 14/912,525

(22) PCT Filed: Aug. 19, 2014
(86) PCT No.: PCT/US14/51661

§ 371 Date: Feb. 17, 2016

Related U.S. Application Data
(60) Provisional application No. 61/867,351, filed on Aug. 19, 2013.

(51) Int. Cl. H01M 4/86; H01M 4/94; H01M 4/92

(52) U.S. Cl. CPC H01M 4/8657; H01M 4/921; H01M 4/94; H01M 4/926; H01M 4/925; H01M 4/8663; H01M 8/0202

(57) ABSTRACT

Disclosed are metal alloy materials comprising iodine adsorbed onto the catalyst surface exhibiting surprisingly improved performance and durability in comparison with known electrocatalysts. Methods of preparation of the catalysts and methods of use thereof are also described.

### RELATED APPLICATION

This application claims benefit of priority to U.S. Provisional Patent Application No. 61/867,351, filed Aug. 19, 2013.

### GOVERNMENT SUPPORT

This invention was made with government support under Grant No. DE-FG02-07ER15895 awarded by the Department of Energy. The government has certain rights in the invention.

### BACKGROUND

One of the challenges facing the development of reliable hydrogen-powered vehicles is the need for oxygen reduction electrocatalysts meeting three major criteria—cost, performance, and durability—that would make mass production of such vehicles feasible. The past fifteen years have seen tremendous progress in meeting these criteria, so that a number of prototype vehicles powered by hydrogen or methanol fuel cells can deliver impressive performance. However, hydrogen or methanol powered vehicles are not yet viable from an economic or practical perspective. Oxygen reduction electrocatalysts are the crucial components necessary for such viability. Hydrogen or methanol-powered vehicles have the potential to provide green and renewable alternatives to the internal compustion engine—an opportunity to revolutionize transportation and other industries.

A hydrogen or methanol-powered fuel cell delivers electricity from the electrochemical oxidation of hydrogen or methanol and the reduction of oxygen to water. It is manufactured as a stack of identical unit cells composed of a membrane electrode assembly (MEA) in which hydrogen gas (H₂) or methanol is oxidized on the anode and oxygen gas (O₂) is reduced on the cathode. Pure water (and very low emissions of CO₂ in the case of methanol) and heat are the only byproducts of the reaction. A solid polymer ion exchange membrane (PEM) is situated between the cathode and anode catalyst layers and allows protons but not electrons to pass from the anode catalyst layer to the cathode catalyst layer. Porous gas diffusion layers transport reactants and water produced by the reaction between the flow fields and catalyst surfaces while exchanging electrons between them.

In terms of the cost requirement mentioned above, even the best electrocatalysts remain prohibitively expensive. This is principally due to the high cost of materials and the lack of reliable mass production methods for most electrocatalyst types. Thus far, the best catalysts require platinum, which is a costly noble metal with a severely limited global supply. Other platinum group metals or alloys thereof can be used, but suffer from similar scarcity and high cost. Based on the current cost of platinum (Pt), it is desirable to reduce Pt cathode loadings to <0.1 mg Pt/cm² without loss of catalytic activity. Current US DOE 2017 targets for electrocatalysts aim for a total (anode+cathode) amount of platinum group metals (PGM) of 0.125 mg/cm² on membrane electrode assemblies (MEAs) capable of producing rated stack power densities of 8.0 kW/g Pt. Such a target would require about 8 g of PGM per vehicle, similar to the amount found in a typical internal combustion engine today. The PGM loading per vehicle can be decreased by increasing the catalytic activity of the electrocatalyst or by substituting less expensive metals or other materials for Pt.

The performance requirement pertains to the catalytic efficiency of the electrocatalyst; currently available electrocatalysts can only meet the necessary oxygen reduction reaction performance at unacceptably high catalyst loadings or cost. Recently-tested prototype vehicles monitored by the DOE have used 0.4 mg of Pt/cm², so a considerable increase in performance is needed to reach the target PGM loadings for 2017 mentioned above. Because the oxygen reduction reaction (ORR) is six orders of magnitude or more slower than the corresponding hydrogen or methanol oxidation taking place on the anode, the electrocatalyst performing the ORR is the key limitation holding back the development of hydrogen or methanol fuel cells.

The durability requirement means, in practical terms, that fuel cells must last long enough that they do not limit the life of the vehicle. Current DOE targets for the year 2017 are 5,000 hours or 10 years of operation. Electrocatalysts must withstand adverse conditions including cool start-ups, cold-start-ups, tolerance of off-nominal conditions and extreme-load transient events, and normal wear and tear comprising hundreds of thousands of load cycles and tens of thousands of start-up and shut-down events. Recently-tested prototypes fall well short of these targets. Pt electrocatalysts lose catalytic efficiency and therefore fail durability targets for a variety of reasons. Because the ORR only takes place on the surface of the electrocatalyst material, any process that reduces the available surface area for binding of O₂ affects the performance and may negatively impact the long-term durability of the electrocatalyst. Such processes include catalyst poisoning, leaching, oxidation, corrosion of the catalyst support, and other factors.

### SUMMARY OF THE INVENTION

The invention provides alloyed metal materials having greatly improved properties over known electrocatalyst materials. Among their improved properties are increased electrochemical activity, large surface area, ease of manufacture, enhanced durability, and resistance to corrosion, catalyst poisoning, degradation, oxidation, metal leaching, and de-alloying. The materials of the present invention, in certain embodiments, meet or exceed the Department of Energy (DOE) benchmarks for oxygen reduction reaction (ORR) activity in fuel cell electrocatalysts for the year 2017. The compounds of the present invention, in certain embodiments, are also highly active catalysts for the methanol oxidation reaction (MOR). Accordingly, the invention provides methods of using the electrocatalyst materials in ORR or MOR chemical reactions for use, e.g., in fuel cells, batteries, generators, or other applications. The invention also provides methods of preparation of the aforementioned improved electrocatalyst materials.

### BRIEF DESCRIPTION OF THE DRAWINGS

FIG. 1 shows a CV plot of the ORR activity of commercial Pt/C (top) and the polarization curve of same (bottom). The specific activity of Pt/C (20%) was 0.182 mA/cm² at 0.9 V, calculated from the Levich-Koutecký equation: 1/i=1/iₖ+1/i_{d}. The mass activity was 0.132 A/mg Pt. The ECSA was 77.3 m²/g.

FIG. 2 shows an overlay of the normal CV plots before and after 5,000 cycles (top) and the ORR polarization curves before and after 5,000 cycles (bottom). There is a large surface loss of commercial Pt/C (20%) of 36.1% (from 0.922 to 0.589 cm²). Additionally, the half wave potential has 18 mV negative shift compared with the initial.

FIG. 3 shows an overlay of normal CV plots (top illustration) of commercial Pt/C for initial (outermost curve), post-5,000 cycles (middle curve), and post-40,000 cycles (inside curve) and corresponding ORR polarization curves (bottom illustration) for initial (rightmost curve), post-5,000 cycles (middle curve), and post-40,000 cycles (leftmost curve). The surface areas are as follows: S₀=0.922 cm²; 73.4 m²/g (1.26 μg/cm²); 1.256 μg; S₅₀₀₀=0.589 cm² (63.9% S₀); 46.9 m²/g; S₄₀₀₀₀=0.163 cm² (17.7% S₀); 8.6 m²/g. The ΔE(5000)_{1/2}=18 mV, and ΔE(40000)_{1/2}=122 mV.

FIG. 4 shows a normal CV plot of commercial Pt black (top) and the ORR polarization curve of commercial Pt black (bottom). The jₛis 0.250 mA/cm² and jₘ is 0.053 A/mg Pt at 0.9 V.

FIG. 5 shows an overlay of the normal CV plots of Pt black before and after 5,000 cycles (top) and the ORR polarization curves before and after 5,000 cycles (bottom). There is a large surface loss, as S₅₀₀₀/S₀=75.63%. Additionally, the half wave potential has 16 mV negative shift compared with the initial.

FIG. 6 shows an overlay of normal CV plots (top illustration) of commercial Pt black for initial (outermost curve), post-5,000 cycles (middle curve), and post-40,000 cycles (inside curve) and ORR polarization curves (bottom illustration) for initial (rightmost curve), post-5,000 cycles (middle curve), and post-40,000 cycles (leftmost curve). The surface areas are as follows: S₀=1.707 cm²; S₅₀₀₀=1.291 cm² (75.63% S₀); S₄₀₀₀₀=0.822 cm² (48.16% S₀). The ΔE(5000)_{1/2}=16 mV, and ΔE(40000)_{1/2}=53 mV.

FIG. 7 shows X-Ray diffraction data for PtNi nanoparticles doped with iodine. The desired PtNi alloy was formed, and all the peaks are between Pt and Ni.

FIG. 8 shows a TEM image of PtNi nanoparticles doped with iodine (top). The average size of the PtNi particles is 2.9±0.6 nm (bottom), which is similar to that of 20% Pt/C. The surface area of 2.9 nm nanoparticles is 86.1 m²/g.

FIG. 9 shows elemental analysis (EDS) data for PtNi(I) nanoparticles prior to washing with HNO₃.

FIG. 10 shows elemental analysis (EDS) data for PtNi(I) nanoparticles after washing with HNO₃.

FIG. 11 shows elemental analysis (EDS) data for PtNi(I) nanoparticles after washing with HNO₃ and further treatment with H₂O₂ to remove the adsorbed I atoms.

FIG. 12 shows the CV plot over 20 cycles of PtNi(I) nanoparticles during CO oxidation to remove the adsorbed I atoms on the surface (top), and a CV plot of PtNi nanoparticles with its surface fully covered by I atoms (bottom).

FIG. 13 shows an overlay of CV plots of PtNi nanoparticles with their surfaces fully covered by adsorbed I atoms (i.e., the as-synthesized sample, inner curve), PtNi(I) after washing with HNO₃ to enrich Pt on the surface (middle curve), and PtNi after HNO₃ wash and removal of all I atoms on the surface (outer curve).

FIG. 14 shows overlays of CV plots comparing a PtNi(I) sample vs. PtNi (i.e. a PtNi nanoparticle with adsorbed I vs. the same sample with no adsorbed I) to determine the percentage of the surface covered by adsorbed I. In the overlay plot for the samples, shown in the top illustration, the S_{I}/Sₙₒ₋₁=1.213/1.276=95.06%, or about 5% I coverage. In the overlay plot for the samples, shown in the bottom illustration, the presence and absence of the adsorbed I atoms are demonstrated by the appearance and lack of oxidation current, respectively, at ˜1.4 V.

FIG. 15 shows a normal CV plot of PtNi(I) nanoparticles (top) and ORR polarization curves comparing the initial graphs of Pt black vs. PtNi(I) (bottom). The PtNi(I) material displays a ΔE_{1/2}of +47 mV relative to Pt black.

FIG. 16 shows CV plots of the initial and post-5,000 cycle accelerated durability tests of Pt(I) samples (top) and the corresponding ORR polarization curves of initial and post-5,000 cycles (bottom). The ΔE(5000)_{1/2} is only −4 mV.

FIG. 17 shows an overlay of CV plots (top illustration) of PtNi(I) nanoparticles for initial (outermost curve), post-5,000 cycles (middle curve), and post-40,000 cycles (inside curve) and corresponding polarization curves (bottom illustration) for initial (rightmost curve), post-5,000 cycles (middle curve), and post-40,000 cycles (leftmost curve). The surface areas are as follows: S₀=1.717 cm²; S₅₀₀₀=1.709 cm² (99.53% S₀); S₄₀₀₀₀=1.411 cm² (82.18% S₀). The ΔE(5000)_{1/}=−4 mV, and ΔE(40000)_{1/2} =−24 mV.

FIG. 18 shows an overlay of CV plots depicting the disappearance of the I⁻ oxidation peak over the course of time. The plots compare the CV curves of 0, 5,000, and 40,000 cycles.

FIG. 19 shows two CV plots of PtNi samples containing no adsorbed iodine with low (top) and high (middle) positive limiting potential and the overlaid ORR polarization curves of Pt black and PtNi with no iodine (bottom). The jₛ of the PtNi was 0.528 mA/cm² vs. 0.250 for Pt black at 0.9 V.

FIG. 20 shows overlays of CV plots of the PtNi material containing a trace or no absorbed iodine of 0 vs. post-5,000 cycles (top) and 0 vs. post-5,000 vs. post-40,000 cycles (bottom). In the bottom overlay, 0 cycles corresponds to the overmost curve, 5,000 cycles corresponds to the middle curve, and 40,000 cycles corresponds to the innermost curve.

FIG. 21 shows an overlay of ORR polarization curves of PtNi material containing a trace or no adsorbed iodine for initial (rightmost curve), post-5,000 cycles (middle curve), and post-40,000 cycles (leftmost curve).

FIG. 22 shows X-Ray diffraction data for PtCu(I) nanoparticles. The diffraction peaks of as-synthesized PtCu(I) nanoparticles match well with PtCu standard PDF card, which demonstrates that both Pt and Cu salt have been reduced completely. The average size of PtCu(I) is 7.5 nm, calculated from the peak at 111 using the Scherrer Equation.

FIG. 23 shows TEM data for PtCu(I) nanoparticles. The TEM results indicate that the PtCu alloy has been successfully synthesized. Moreover, the average size of the PtCu nanoparticles is about 7 nm. Surface area calculations for average particle size of 6.96 nm: 39.6 m²/g.

FIG. 24 shows elemental analysis (EDS) data for PtCu(I) nanoparticles prior to washing with HNO₃.

FIG. 25 shows elemental analysis (EDS) data for PtCu(I) nanoparticles after washing with HNO₃.

FIG. 26 shows elemental analysis (EDS) data for PtCu(I) nanoparticles after washing with HNO₃ and further treatment with H₂O₂ to remove the adsorbed I atoms.

FIG. 27 shows normal CV plots of the PtCu(I) nanoparticles with low (top) and high (bottom) positive limiting potential, with the oxidation peak at ˜1.35 V in the latter indicating the presence of I.

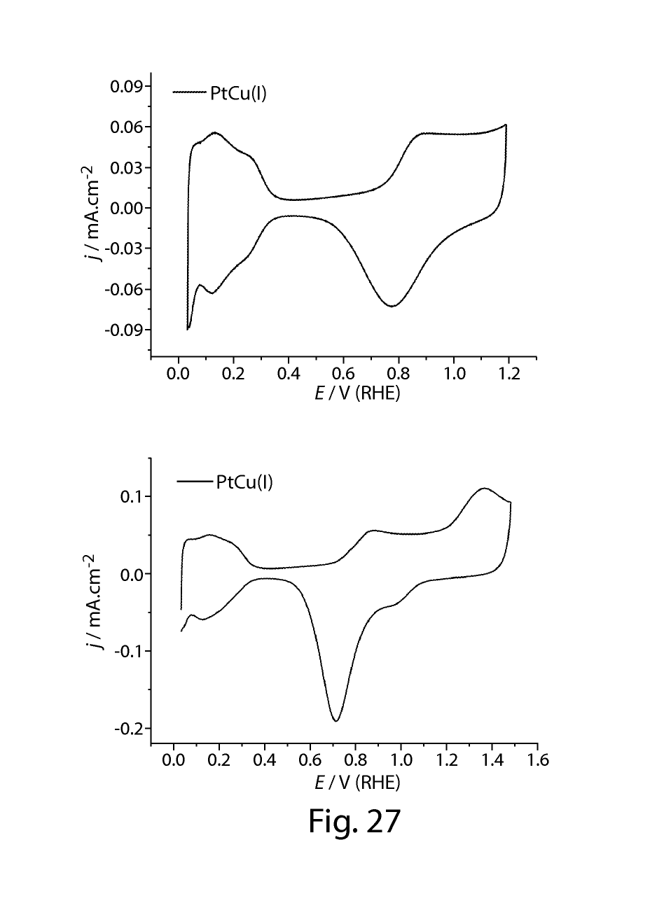

FIG. 28 shows the normal CV plots of Pt/C (20%) vs. PtCu(I) nanoparticles (top) and ORR polarization curves comparing the ORR activity of Pt/C (20%) vs. PtCu(I) (bottom). The PtCu(I) material displays a ΔE_{1/2} of +55 mV relative to Pt/C. The specific activity of the PtCu(I) alloy is 1.286 mA/cm² at 0.9 V, calculated from Levich-Koutecký equation: 1/i=1/iₖ+1/i_{d}, which is 7.1 times higher than commercial Pt/C (0.182 mA/cm² at 0.9 V). The mass activity of Pt/C is 0.134 A/mg Pt. The ECSA of Pt/C is 73.4 m²/g. The CVs in the inset of the bottom illustration indicate the existence of adsorbed iodine on the PtCu(I) nanoparticles by the oxidation peak at 1.36 V.

FIG. 29 shows the results of an accelerated stability test of the PtCu(I) alloyed nanoparticles. The loss in ECSA was less than 4% and the negative shift of the half-wave potential was merely 6 mV (13% decrease in specific kinetic current at 0.9 V) after having been subjected to 5,000 cycles of accelerated stability test.

FIG. 30 shows an overlay of CV plots (top) of PtCu(I) nanoparticles for initial (outer curve) and post-40,000 cycles (inside curve) and an overlay of CV curves (bottom) of Pt/C (20%) for initial (outer curve) and post-40,000 cycles (inner curve). The surface areas (ECSA) are as follows: for PtCu(I), S₀=0.939 cm²; S₄₀₀₀₀=0.717 cm² (76.36% S₀). For Pt/C, S₀=0.922 cm²; S₄₀₀₀₀=0.163 cm² (17.7% S₀).

FIG. 31 shows the ORR polarization curves (top) of PtCu(I) initial vs. PtCu(I) after being subjected to the durability test for 40,000 cycles; the ORR polarization curves (middle) of Pt/C (20%) initial vs. Pt/C after being subjected to the durability test for 40,000 cycles; and a table (bottom) of the electrochemical properties of PtCu(I) compared with Pt/C (20%) and Pt black.

FIG. 32 shows an overlay of CV plots demonstrating that for PtCu(I) nanoparticles the peak at 1.36 V from the oxidation of surface iodine atoms disappears over time during the durability test.

FIG. 33 shows a CV plot overlay of the disappearance of the iodine peak on PtCu(I) nanoparticles during removal of the iodine by CO oxidation over the course of 20 cycles.

FIG. 34 shows an overlay of normal CV plots (top) comparing PtCu(I) vs. PtCu without adsorbed iodine and an overlay of alternate CV plots (bottom) comparing PtCu(I) vs. PtCu without adsorbed iodine. The S₁/S₀=2.261/2.376=95.16%, or about 4.8% I coverage, for the top illustration. The adsorbed iodine atoms were removed by treatment with H₂O₂ combined with UV irradiation for 2 h. Fresh H₂O₂ aqueous solution (1.5 mL) was added every 15 minutes. CV results indicate two I⁻ peaks disappeared, which means there is no iodine on the PtCu surface after UV/H₂O₂ treatment.

FIG. 35 shows an overlay of CV plots (top) of the PtCu nanoparticles lacking adsorbed iodine atoms after 0 (outermost curve), post-5,000 (middle curve), and post-40,000 (innermost curve) cycles of durability testing and analysis of the surface area during the durability testing (bottom), with data for Pt/C (20%) and Pt black for comparison.

FIG. 36 shows an overlay of CV plots with high positive limiting potential (top) of PtCu nanoparticles lacking adsorbed iodine atoms after 0 (outer curve) and post-5,000 (inner curve) cycles of durability testing, and (bottom) an overlay of CV plots of high positive limiting potential comparing 0 (outermost curve), post-5,000 (middle curve), and post-40,000 (innermost curve) cycles of durability testing. Lack of the oxidation current at ˜1.35 V for all CVs indicate the absence of adsorbed I.

FIG. 37 shows an overlay of ORR polarization curves (top) of PtCu nanoparticles lacking adsorbed iodine atoms after 0 (rightmost curve), post-5,000 (middle curve), and post-40,000 (leftmost curve) cycles of durability testing, and (bottom) data for the loss of surface area over the course of durability testing.

FIG. 38 shows a summary of electrochemical properties of electrocatalysts with 2017 DOE targets for hydrogen-powered vehicles.

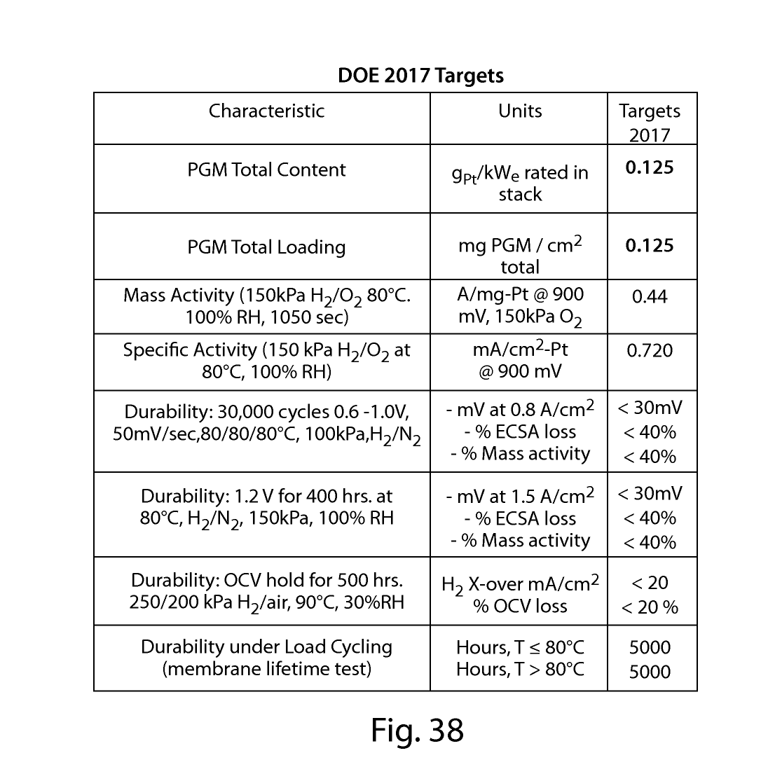

FIG. 39 shows a summary of electrochemical activity data for some of the materials of the invention.

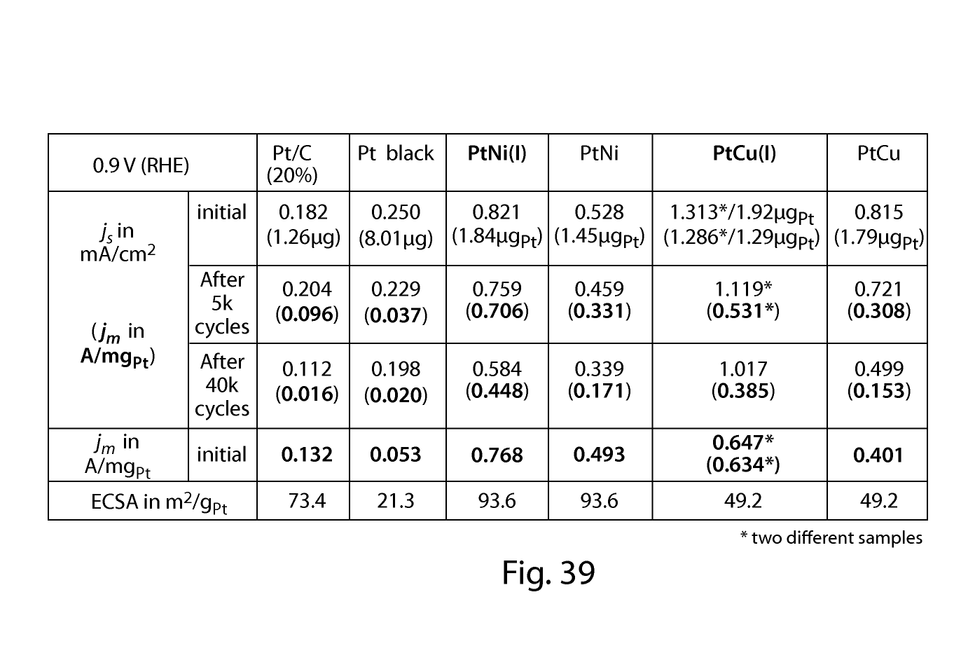

FIG. 40 shows a summary of electrochemical durability data for some of the materials of the invention.

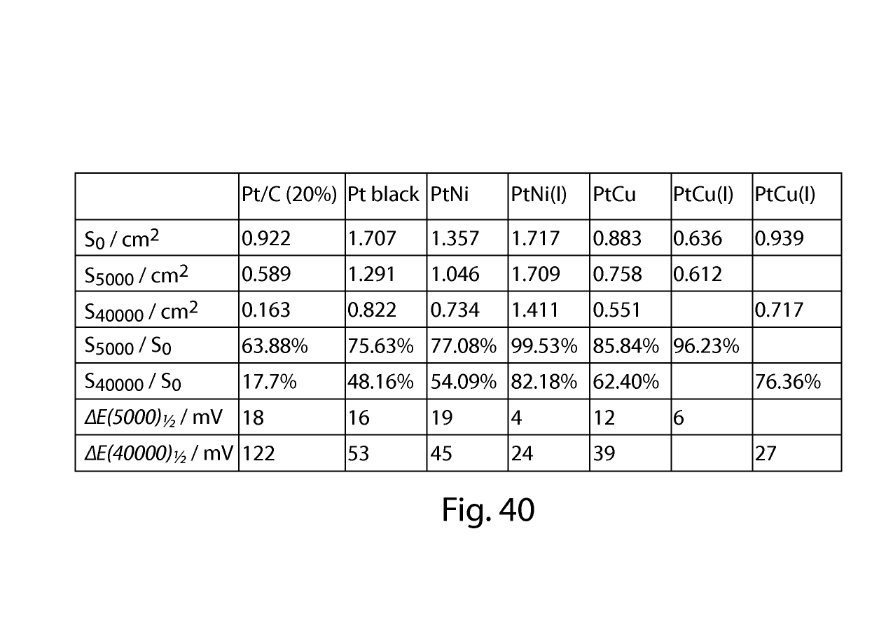

FIG. 41 shows CVs (A) and CAs (B) of MOR for PtCu alloyed NPs and Pt/C.

FIG. 42 compares the sulfide adsorption isotherms for Pt/C and PtCu alloyed NPs with adsorbed iodine. The PtCu alloyed NPs demonstrate much slower sulfide uptake, suggesting better tolerance to sulfur-poisoning.

### DETAILED DESCRIPTION

The invention generally concerns alloyed metal materials whose surfaces are doped or coated with adsorbed iodine atoms. The iodine influences the electrochemical properties of the materials, yielding unexpectedly improved current density and resistance to corrosion, catalyst poisoning, degradation, oxidation, metal leaching, and de-alloying. The unexpectedly high current density makes the materials useful as, for example, electrocatalysts in the oxygen reduction reaction or the methanol oxidation reaction. Such reactions are the basis for many useful technologies such as hydrogen fuel cells and methanol fuel cells, respectively. The electrocatalyst materials have in certain embodiments a core/shell structure comprising an inner layer or core underneath an outer layer or shell.

The core comprises one or more metal alloys. The shell comprises Pt metal optionally alloyed with small amounts of another metal; or Mₛₕₑₗₗ is, M in certain embodiments, enriched in Pt or predominantly Pt. The Mₛₕₑₗₗ may also, in certain embodiments, be a nanoporous structure of high surface area. In certain embodiments the electrocatalyst materials are made up of nanoparticles.

It has been observed that alloyed nanoparticles, such as alloyed nanoparticles comprising Pt and another metal, can have enhanced ORR activity but also have long-term stability problems due to easy oxidation and de-alloying of the non-Pt metal. In certain embodiments the present invention provides alloyed metal particles having enhanced ORR activity, MOR activity, or other electrochemical activity, and enhanced durability and resistance to oxidation, dealloying, and other undesirable events at the metal surface.

In certain aspects the invention relates to a particle having a core/shell structure, comprising a core represented by M_{core}; a shell represented by M and a plurality of adsorbed iodine atoms on the surface of Mₛₕₑₗₗ;

wherein

M_{core} comprises a metal alloy of formula PtM; M is selected from the group consisting of Mn, Fe, Co, Ni, Cu, Ru, Pd, Ag, and Au; and the ratio of Pt:M is about 1:5 to about 5:1;

Mₛₕₑₗₗ comprises one to five layers of Pt atoms alloyed with up to about 10% M atoms; and

said particle has a diameter from about 2 nm to about 12 nm.

In certain embodiments, greater than 0% to about 10% of the surface of the particle is covered by the adsorbed iodine atoms.

In certain embodiments, the adsorbed iodine atoms represent greater than 0% to about 10% of the particle by weight.

In certain embodiments, the ratio of Pt:M in M_{core} is about 1:4 to about 4:1.

In certain embodiments, the ratio of Pt:M in M_{core} is about 1:3 to about 3:1.

In certain embodiments, the ratio of Pt:M in M_{core} is about 1:2 to about 2:1.

In certain embodiments, the ratio of Pt:M in M_{core} is about 1:1.

In certain embodiments, the particle has a diameter of about 3 to about 11 nm.

In certain embodiments, the particle has a diameter of about 2 to about 7 nm.

In certain embodiments, the particle has a diameter of about 6.0 to about 8.2 nm.

In certain embodiments, the particle has a diameter of about 2.2 to about 3.6 nm.

In certain embodiments, the metal alloy in M_{core} is selected from the group consisting of PtNi, PtCu, PtRu, and PtAg.

In certain embodiments, the metal alloy in M_{core} is PtCu.

In certain embodiments, the metal alloy in M_{core} is PtNi.

In certain embodiments, the adsorbed iodine atoms represent about 1% to about 8% of the particle by weight.

In certain embodiments, the adsorbed iodine atoms represent about 2% to about 7% of the particle by weight.

In certain embodiments, the adsorbed iodine atoms represent about 3.5% to about 5.5% of the particle by weight.

In certain embodiments, about 1% to about 8% of the surface of the particle is covered by the adsorbed iodine atoms.

In certain embodiments, about 2% to about 7% of the surface of the particle is covered by the adsorbed iodine atoms.

In certain embodiments, about 3.5% to about 5.5% of the surface of the particle is covered by the adsorbed iodine atoms.

In certain embodiments, the adsorbed iodine atoms represent about 4.2 wt % of the particle; and about 5.0% of the surface of the particle is covered by the adsorbed iodine atoms.

In certain aspects, the invention relates to an aggregate, comprising a plurality of particles as described above.

In certain embodiments, the particles have an average diameter of about 6.0 to about 8.2 nm.

In certain embodiments, the particles have an average diameter of about 2.2 to about 3.6 nm.

In certain embodiments, the particles further comprise a solid support.

In certain embodiments, the solid support is selected from the group consisting of activated carbon, carbon black, carbon cloth, carbon fiber paper, carbon nanotubes, carbon fibers, graphite, and a polymer.

In certain embodiments, the loss of electrochemical surface area is less than 20% after the composite material is subjected to a voltage of 0.6 V to 1.1 V while immersed in 0.1 M HClO₄ saturated with O₂ at 50 mV/s for 5,000 cycles.

In certain embodiments, the loss of electrochemical surface area is less than 10% after the composite material is subjected to a voltage of 0.6 V to 1.1 V while immersed in 0.1 M HClO₄ saturated with O₂ at 50 mV/s for 5,000 cycles.

In certain embodiments, the loss of electrochemical surface area is less than 5% after the composite material is subjected to a voltage of 0.6 V to 1.1 V while immersed in 0.1 M HClO₄ saturated with O₂ at 50 mV/s for 5,000 cycles.

In certain embodiments, the loss of electrochemical surface area is less than about 1% after the composite material is subjected to a voltage of 0.6 V to 1.1 V while immersed in 0.1 M HClO₄ saturated with O₂ at 50 mV/s for 5,000 cycles.

In certain embodiments, the loss of electrochemical surface area is less than 40% after the composite material is subjected to a voltage of 0.6 V to 1.1 V while immersed in 0.1 M HClO₄ saturated with O₂ at 50 mV/s for 40,000 cycles.

In certain embodiments, the loss of electrochemical surface area is less than 25% after the composite material is subjected to a voltage of 0.6 V to 1.1 V while immersed in 0.1 M HClO₄ saturated with O₂ at 50 mV/s for 40,000 cycles.

In certain embodiments, the loss of electrochemical surface area is less than 15% after the composite material is subjected to a voltage of 0.6 V to 1.1 V while immersed in 0.1 M HClO₄ saturated with O₂ at 50 mV/s for 40,000 cycles.

In certain embodiments, the loss of half wave potential is less than about 15 mV after 5,000 cycles at a voltage of 0.6 to 1.1 V while immersed in 0.1 M HClO₄ saturated with O₂ at 50 mV/s.

In certain embodiments, the loss of half wave potential is less than about 7.5 mV after 5,000 cycles at a voltage of 0.6 to 1.1 V while immersed in 0.1 M HClO₄ saturated with O₂ at 50 mV/s.

In certain embodiments, the loss of half wave potential is less than about 5 mV after 5,000 cycles at a voltage of 0.6 to 1.1 V while immersed in 0.1 M HClO₄ saturated with O₂ at 50 mV/s.

In certain embodiments, the loss of half wave potential is less than about 60 mV after 40,000 cycles at a voltage of 0.6 to 1.1 V while immersed in 0.1 M HClO₄ saturated with O₂ at 50 mV/s.

In certain embodiments, the loss of half wave potential is less than about 30 mV after 40,000 cycles at a voltage of 0.6 to 1.1 V while immersed in 0.1 M HClO₄ saturated with O₂ at 50 mV/s.

In certain embodiments, the loss of half wave potential is less than about 20 mV after 40,000 cycles at a voltage of 0.6 to 1.1 V while immersed in 0.1 M HClO₄ saturated with O₂ at 50 mV/s.

In certain embodiments, the absolute ORR kinetic activity of the material prior to use is greater than about 0.9 mA/cm2 measured at 0.9 V under 1.0 atm of fully saturated O₂ at 80° C.

In certain embodiments, the absolute ORR kinetic activity of the material prior to use is from about 0.8 to about 0.9 mA/cm² measured at 0.9 V under 1.0 atm of fully saturated O2 at 80° C.

In certain embodiments, the absolute ORR kinetic activity of the material prior to use is from about 0.7 to about 0.8 mA/cm² measured at 0.9 V under 1.0 atm of fully saturated O₂ at 80° C., wherein the absolute ORR kinetic activity is measured at 0.9 V under 1.0 atm of fully saturated pure O₂ at 80° C.

In certain embodiments, the absolute ORR kinetic activity of the material after exposure to a voltage of 0.6 to 1.1 V while immersed in 0.1 M HClO₄ saturated with O₂ at 50 mV/s for 5,000 cycles is greater than about 0.7 mA/cm², wherein the absolute ORR kinetic activity is measured at 0.9 V under 1.0 atm of fully saturated pure O₂ at 80° C.

In certain embodiments, the absolute ORR kinetic activity of the material after exposure to a voltage of 0.6 to 1.1 V while immersed in 0.1 M HClO₄ saturated with O₂ at 50 mV/s for 40,000 cycles is greater than about 0.5 mA/cm², wherein the absolute ORR kinetic activity is measured at 0.9 V under 1.0 atm of fully saturated pure O₂ at 80° C.

In certain embodiments, the initial mass activity is greater than 0.7 mA/mg Pt, measured at 0.9 V under 1.0 atm of fully saturated pure O₂ at 80° C.

In certain aspects, the invention relates to a membrane electrode assembly (MEA) for a fuel cell, comprising an ion exchange membrane; and a catalyst layer comprising an aggregate as described above.

In certain embodiments, the MEA further comprises a gas diffusion layer associated with the catalyst layer.

In certain embodiments, the ion exchange membrane is a proton exchange membrane.

In certain embodiments, the MEA further comprises bi-polar plates for the introduction of gaseous reactants and coolants and the harvesting of electrical current.

In certain embodiments, the MEA is suitable for use as a catalyst in an oxygen reduction reaction (ORR).

In certain embodiments, the MEA further comprises a source of O₂.

In certain embodiments, the O₂ is pure O₂ or a mixture of gases comprising about 10% to 100% O₂.

In certain embodiments, the MEA is suitable for use as a catalyst in a methanol oxidation reaction (MOR).

In certain embodiments, the MEA is suitable for use in a hydrogen-powered vehicle.

In certain embodiments, the MEA is suitable for use in a methanol-powered vehicle.

In certain aspects, the invention relates to a method of preparing a particle as described above, or an aggregate as described above, comprising the steps of:

(i) providing a first compound comprising Pt, a second compound comprising a metal selected from the group consisting of Mn, Fe, Co, Ni, Cu, Ru, Pd, Ag, and Au, and a third compound comprising iodine or iodide;

(ii) combining the first compound, the second compound, and the third compound, thereby forming a crude product; and

(iii) washing the crude product with a solution comprising an acid, thereby forming the particle or aggregate.

In certain embodiments, the second compound comprises Ni, Cu, Ru, or Ag.

In certain embodiments, the second compound comprises Cu.

In certain embodiments, the second compound comprises Ni. p In certain embodiments, the stoichiometry of the first compound to the second compound is about 1:1.

In certain other embodiments of the above method of preparing a particle, step (i) further comprises a reducing agent.

In certain embodiments, the reducing agent is selected from the group consisting of lithium borohydride, sodium borohydride, potassium borohydride, and formaldehyde.

In certain embodiments, the Pt in the first compound is in the +1 oxidation state.

In certain embodiments, the Pt in the first compound is in the +2 oxidation state.

In certain embodiments, the Mn, Fe, Co, Ni, Cu, Ru, Pd, Ag, or Au in the second compound is in the +1 oxidation state.

In certain embodiments, the Mn, Fe, Co, Ni, Cu, Ru, Pd, Ag, or Au in the second compound is in the +2 oxidation state.

In certain embodiments, the second compound comprises Cu²⁺.

In certain embodiments, the second compound comprises Ni²⁺.

In certain embodiments, the third compound comprises iodide.

In certain embodiments, the third compound comprises sodium iodide.

In certain embodiments, step (ii) is performed at about 100 to about 300° C.

In certain embodiments, step (ii) is performed at about 160° C. for approximately 5 h.

In certain embodiments, the acid comprises an oxidizing acid.

In certain embodiments, the acid comprises HNO₃.

In certain embodiments, the particle comprises on its surface a shell layer enriched in Pt.

In certain embodiments, the particle comprises Cu.

In certain embodiments, the particle comprises Ni.

One aspect of the invention relates to an electrode for an electrochemical cell, wherein the electrode comprises an aggregate as described above.

### Definitions

The acronym “ORR” stands for oxygen reduction reaction. The oxygen reduction reaction is the reduction of O₂ to H₂O.

The acronym “MOR” stands for methanol oxidation reaction. The term “methanol oxidation reaction” refers to the oxidation of methanol to CO₂ and H₂O.

The acronym “PEM” as used herein means “polymer ion exchange membrane.”

The acronym “MEA” as used herein means “membrane electrode assembly”.

The acronym “NP” as used herein means nanoparticle.

The acronym “COR” as used herein means CO (carbon monoxide) oxidation reaction.

The acronym “PGM” as used herein stands for “platinum group metals”.

The acronym “RHE” as used herein stands for “reversible hydrogen electrode”. It is a standard reference electrode. When (RHE) appears after a number, it indicates that the number was measured by comparison with an RHE.

The acronyms “RDE” or “RDE apparatus” as used herein stands for rotating disc electrode apparatus.

The acronym “ECSA” as used herein means “electrochemical surface area”.

The acronym “EASA” as used herein means “electrochemical active surface area”.

The term “acid” includes all inorganic or organic acids. Inorganic acids include mineral acids such as hydrohalic acids, such as hydrobromic and hydrochloric acids, sulfuric acids, phosphoric acids and nitric acids. Organic acids include all aliphatic, alicyclic and aromatic carboxylic acids, dicarboxylic acids, tricarboxylic acids, and fatty acids. Preferred acids are straight chain or branched, saturated or unsaturated C1-C20 aliphatic carboxylic acids, which are optionally substituted by halogen or by hydroxyl groups, or C6-C12 aromatic carboxylic acids. Examples of such acids are carbonic acid, formic acid, fumaric acid, acetic acid, propionic acid, isopropionic acid, valeric acid, alpha-hydroxy acids, such as glycolic acid and lactic acid, chloroacetic acid, benzoic acid, methane sulfonic acid, and salicylic acid. Examples of dicarboxylic acids include oxalic acid, malic acid, succinic acid, tataric acid and maleic acid. An example of a tricarboxylic acid is citric acid. Fatty acids include all pharmaceutically acceptable saturated or unsaturated aliphatic or aromatic carboxylic acids having 4 to 24 carbon atoms. Examples include butyric acid, isobutyric acid, sec-butyric acid, lauric acid, palmitic acid, stearic acid, oleic acid, linoleic acid, linolenic acid, and phenylsteric acid. Other acids include gluconic acid, glycoheptonic acid and lactobionic acid.

The term “base” contemplates all inorganic or organic bases. Inorganic bases include mineral bases such as halides, such as bromide and chloride, sulfates, phosphates and nitrates. Organic bases include all aliphatic, alicyclic and aromatic amines and dibasic amino acids. Examples of bases include sulfate salts, nitrate salts, bisulfate salts, carbonate salts, bicarbonate salts, phosphate salts, ammonia, triethylamine, guanidine, pyridine, and the like.

The invention having been described, it will be further understood by reference to the following non-limiting examples.

### EXEMPLIFICATION

### Example 1

### Synthesis of PtNi Electrocatalyst Containing Adsorbed Iodine Atoms

PtNi(I) (particles of PtNi alloy containing adsorbed iodine atoms) were prepared by the following hydrothermal method: to a flask containing 15.7 mg Pt(acac)₂, 10.8 mg of Ni(acac)₂, and 150 mg NaI were added 8 mL acetone and 4 mL 37% HCHO. The resulting mixture was subjected to sonication for 5-10 minutes. The resulting homogeneous solution was transferred to a 20 mL Teflon-lined stainless-steel autoclave. The vessel was sealed and heated at 160° C. for 5 h, then allowed to cool to room temperature. The crude product was separated via centrifugation at 7,000 rpm for 20 minutes, and further washed once with nitric acid aqueous solution (conc. HNO₃:H₂O=1:1 volume ratio) followed by deionized water/ethanol/acetone solution (ethanol:acetone:water=1:1:1 volume ratio) and ethanol in sequence several times to remove byproducts and salts. Finally, the purified product was dispersed in ethanol for further use.

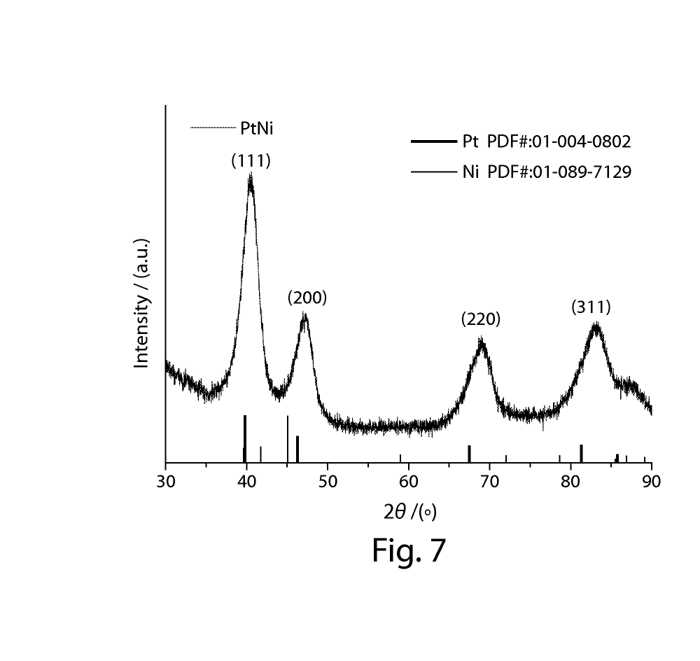

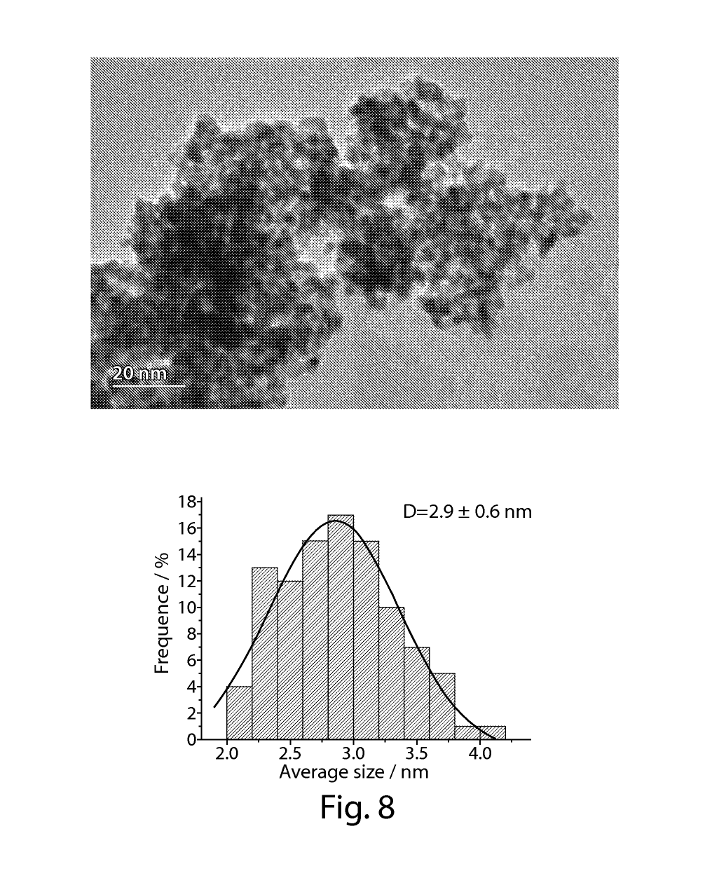

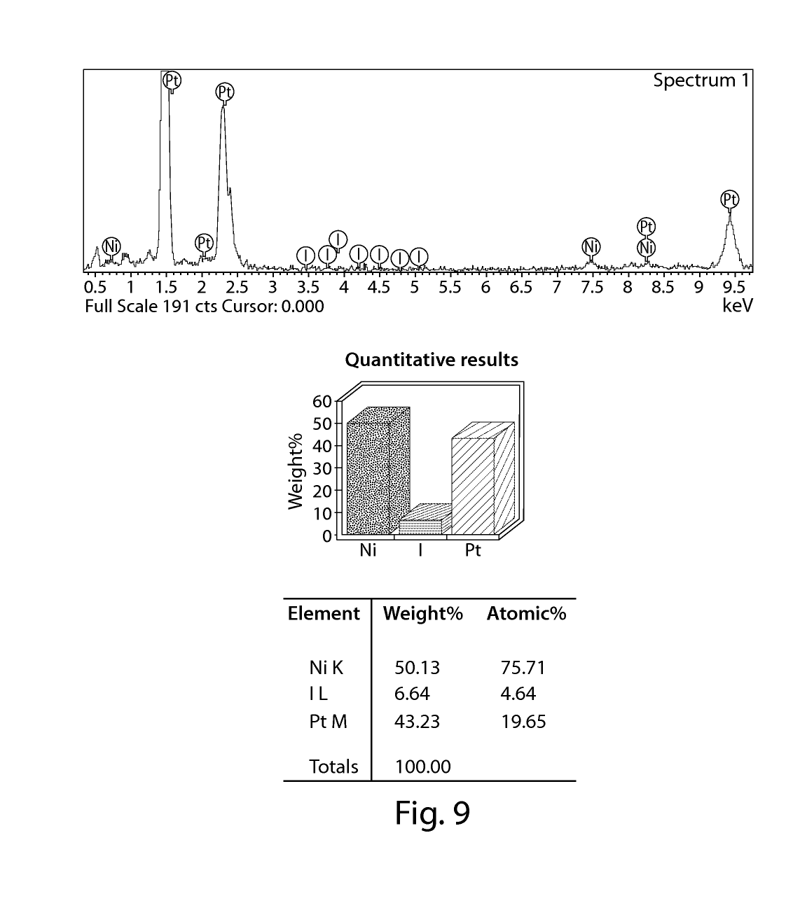

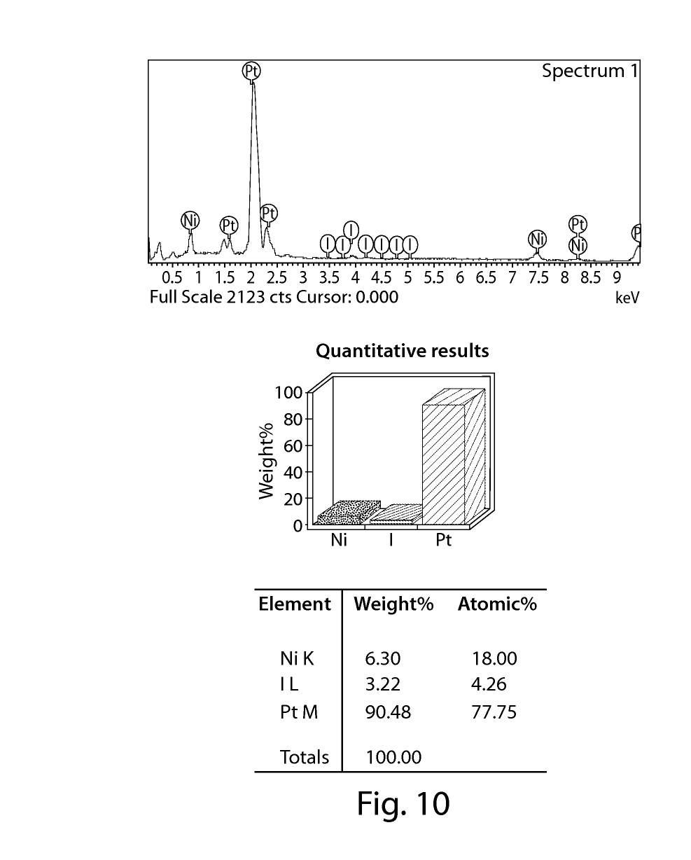

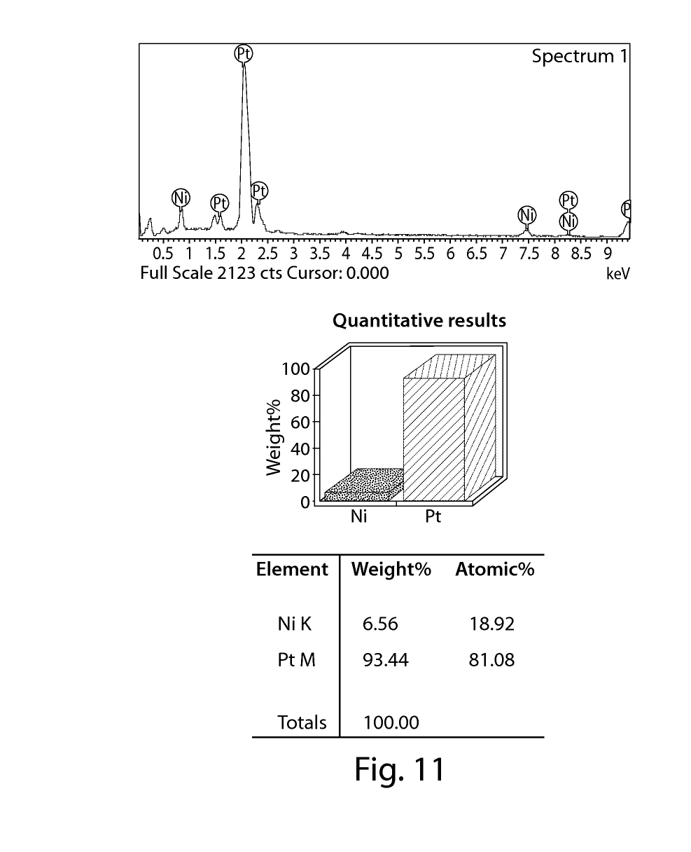

FIGS. 7-11 show X-Ray diffraction data, TEM data, and elemental analysis of the PtNi(I) particles produced by this method.

### Example 2

### Synthesis of PtCu Electrocatalyst Containing Adsorbed Iodine Atoms

PtCu(I) (particles of PtCu alloy containing adsorbed iodine atoms) were prepared by the following hydrothermal method: To a flask containing 15.7 mg Pt(acac)₂, 8 mg of Cu(II) acetate hydrate, and 150 mg NaI were added 8 mL acetone and 4 mL 37% HCHO. The resulting mixture was subjected to sonication for 5-10 minutes. The resulting homogeneous solution was transferred to a 20 mL Teflon-lined stainless-steel autoclave. The vessel was sealed and heated at 160° C. for 5 h, then allowed to cool to room temperature. The crude product was separated via centrifugation at 7,000 rpm for 20 minutes, and further washed once with nitric acid aqueous solution (conc. HNO₃:H₂O=1:1 volume ratio) followed by deionized water/ethanol/acetone solution (ethanol:acetone:water=1:1:1 volume ratio) and ethanol in sequence several times to remove byproducts and salts. Finally, the purified product was dispersed in ethanol for further use.

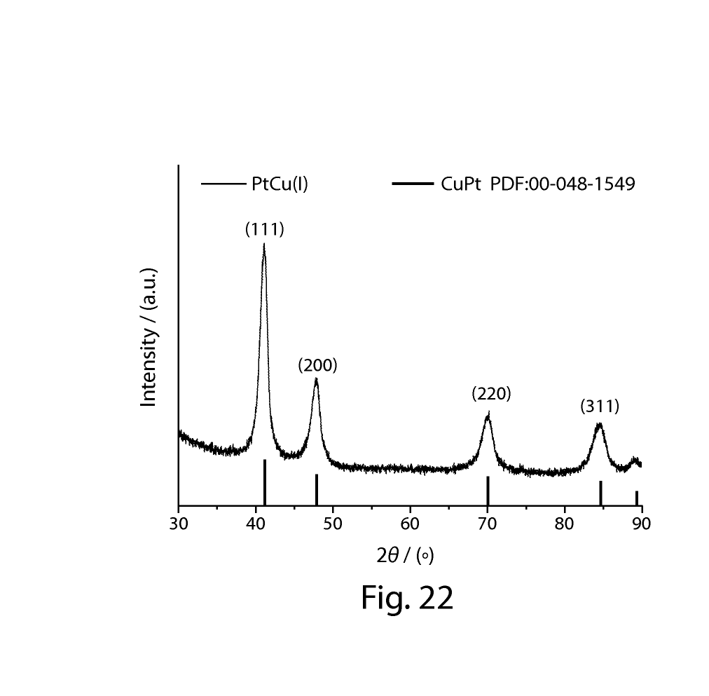

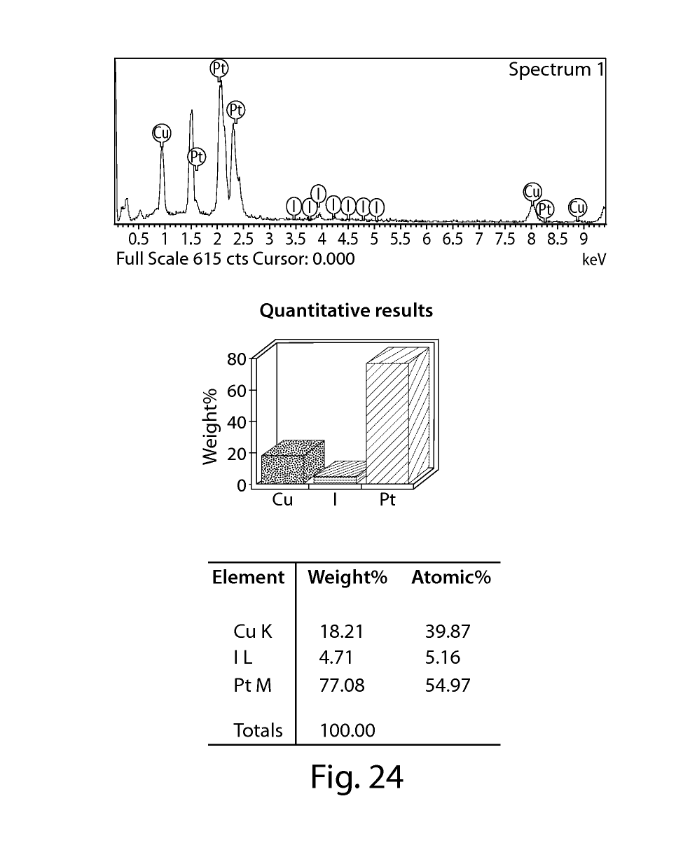

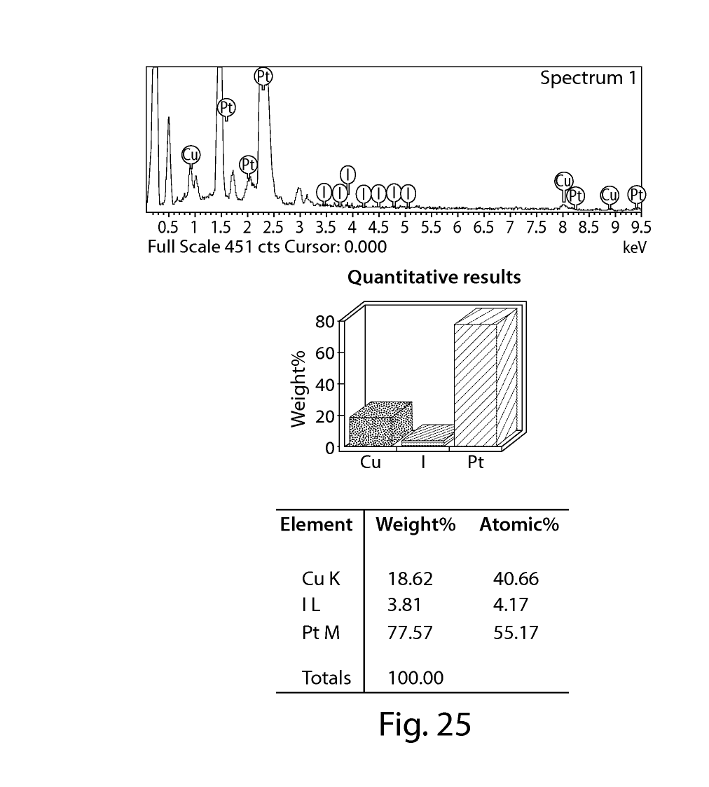

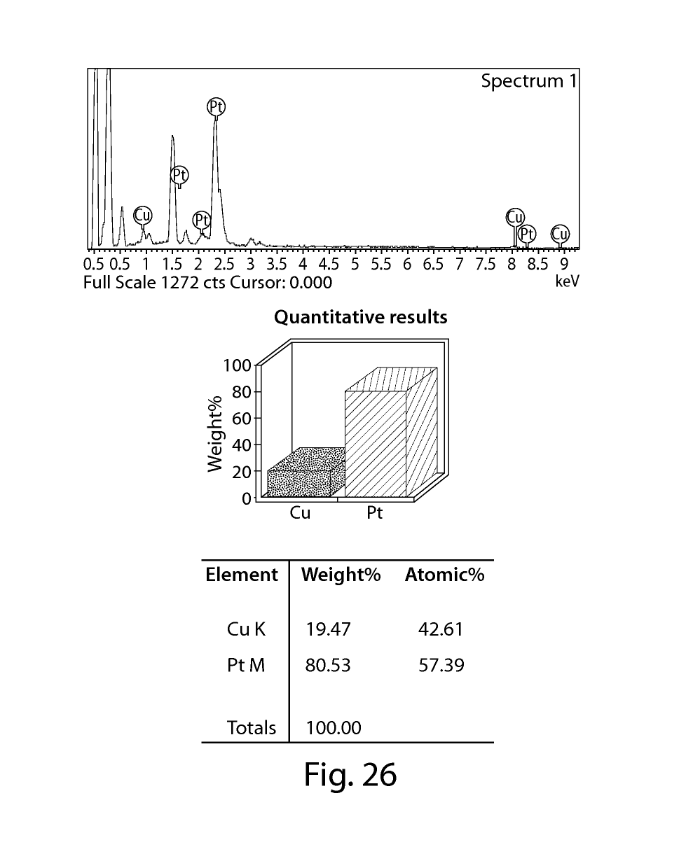

FIGS. 22-26 show X-Ray diffraction data, TEM data, and elemental analysis of the PtCu(I) particles produced by this method.

### Example 3

### Electrochemical Properties and Durability of Commercial Pt/C and Pt Black

The ORR activity was measured under the following conditions: voltage from 0.03 to 1.1 V at a rate of 10 mV/s in O₂ saturated 0.1 M HClO₄ at 1600 rpm (rotating disk method). Durability tests were performed under the following conditions: from 0.6 to 1.1 V at 50 mV/s in O₂ saturated 0.1 M HClO₄.

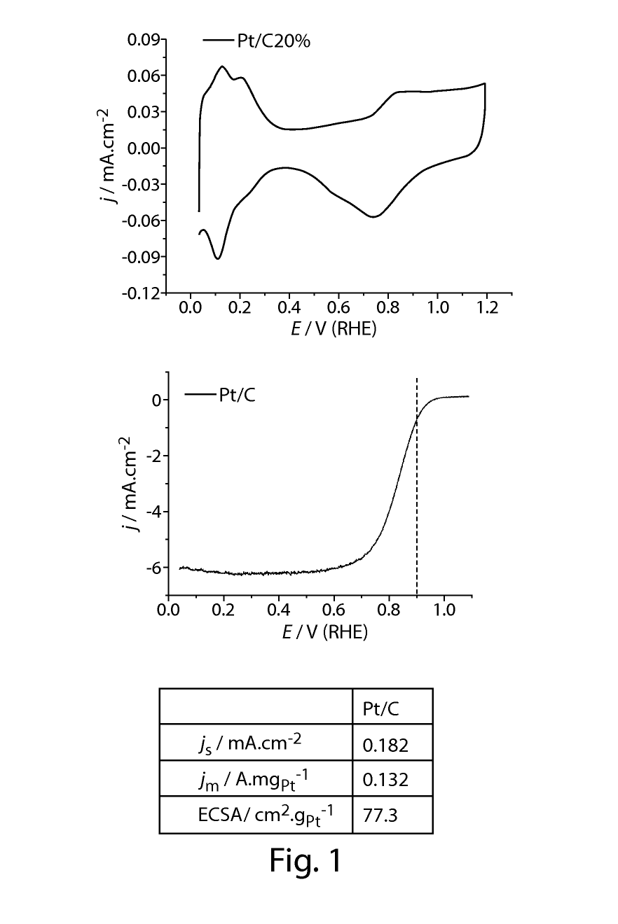

As a benchmark, commercial-grade 20% platinum on carbon (Pt/C) was measured for ORR activity as initially received. FIG. 1 shows a CV plot of the ORR activity of commercial Pt/C (20%) (top) and the polarization curve of same (bottom). The specific activity of Pt/C was 0.182 mA/cm², calculated from the Levich-Koutecký equation: 1/i=1/iₖ+1/i_{d}. The mass activity was 0.132 A/mg Pt. The ECSA was 77.3 m²/g.

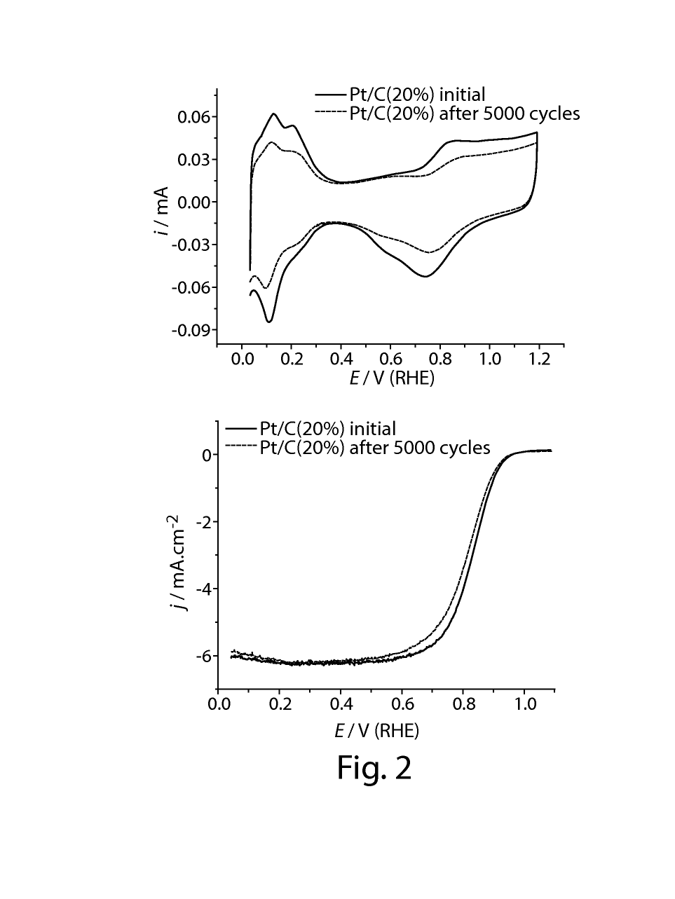

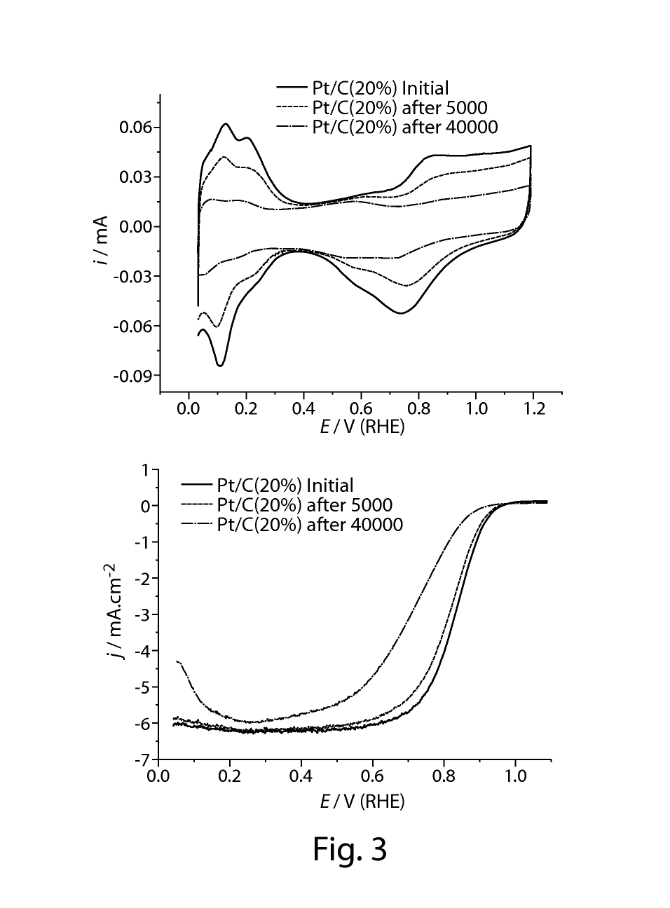

FIG. 2 shows an overlay of the CV plots before and after 5,000 cycles (top) and the ORR polarization curves before and after 5,000 cycles (bottom). There is a large surface loss of commercial Pt/C (20%) of 36.1% (from 0.922 to 0.589 cm²). Additionally, the half wave potential has a 18 mV negative shift compared with the initial. When the CV plots (FIG. 3, top illustration) of commercial Pt/C are overlaid for initial (outermost curve), post-5,000 cycles (middle curve), and post-40,000 cycles (inside curve), one can see a dramatic loss of electrochemical activity over the course of the durability test. Polarization curves demonstrate the same trend (FIG. 3, bottom illustration) from initial (rightmost curve), over 5,000 cycles (middle curve), and 40,000 cycles (leftmost curve). The surface areas are as follows: S₀=0.922 cm²; 73.4 m²/g (1.26 μg/cm²); 1.256 μg; S₅₀₀₀=0.589 cm² (63.9% S₀); 46.9 m²/g; S₄₀₀₀₀=0.163 cm² (17.7% S₀); 8.6 m²/g. The ×E(5000)_{1/2}=18 mV, and ΔE(40000)_{1/2}=122 mV.

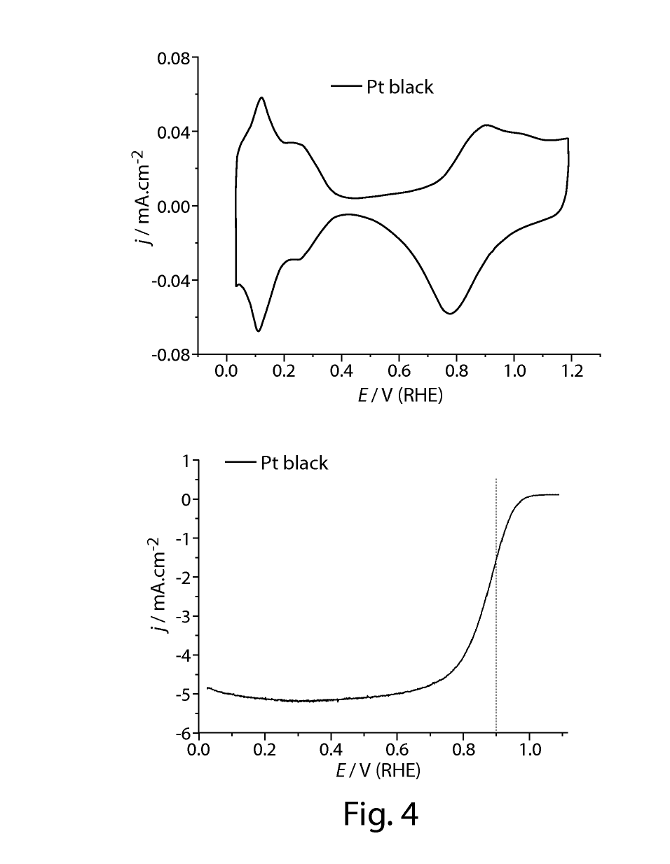

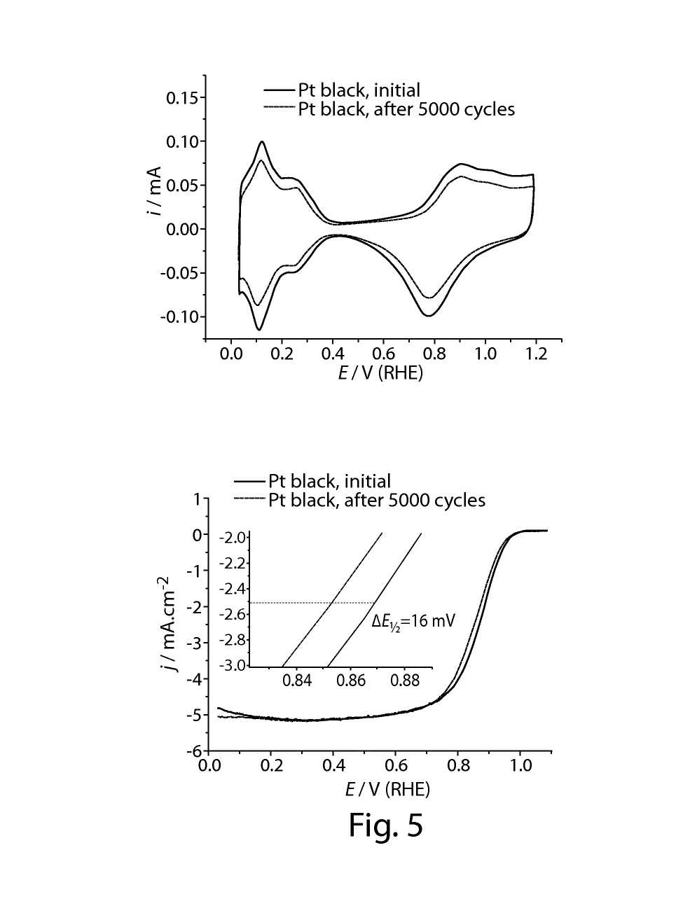

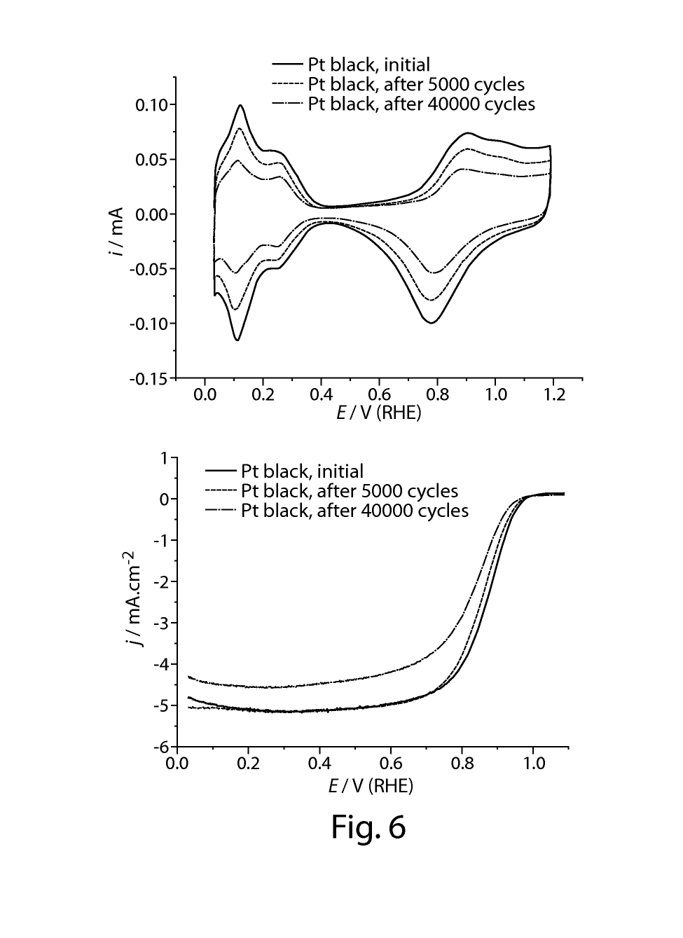

The same analyses were performed for commercial Pt black. FIG. 4 shows a CV plot of the commercial Pt black (top) and the ORR polarization curve of commercial Pt black. The jₛ is 0.250 mA/cm² and jₘ is 0.053 A/mg Pt at 0.9 V. FIG. 5 shows an overlay of the CV plots of Pt black before and after 5,000 cycles (top) and the ORR polarization curves before and after 5,000 cycles (bottom). There is a large surface loss, as S₅₀₀₀/S₀=75.63%. Additionally, the half wave potential has a negative shift of 16 mV compared with the initial. Finally, an overlay of CV plots (FIG. 6, top illustration) of commercial Pt black for initial (outermost curve), post-5,000 cycles (middle curve), and post-40,000 cycles (inside curve) show that the loss of electrochemical surface area is precipitous over the course of the durability test, but somewhat better than for Pt/C. ORR polarization curves (FIG. 6, bottom illustration) for initial (rightmost curve), post-5,000 cycles (middle curve), and post-40,000 cycles (leftmost curve) show the same trend. The surface areas are as follows: S₀=1.707 cm²; S₅₀₀₀=1.291 cm² (75.63% S₀); S₄₀₀₀₀=0.822 cm² (48.16% S₀). The ΔE(5000)_{1/2}=16 mV, and ΔE(40000)_{1/2}=53 mV.

### Example 4

### Electrochemical Properties of PtNi Nanoparticles Containing Adsorbed Iodine Atoms

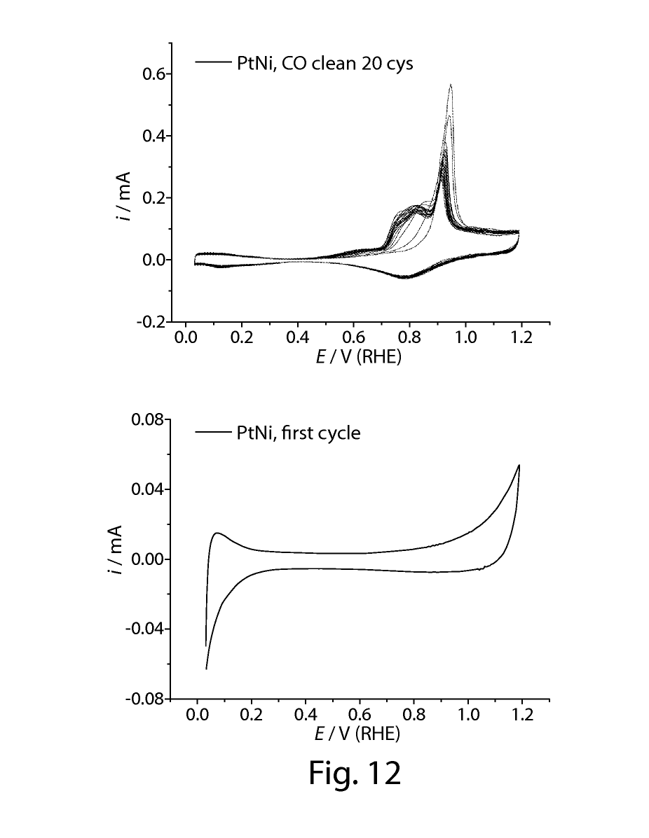

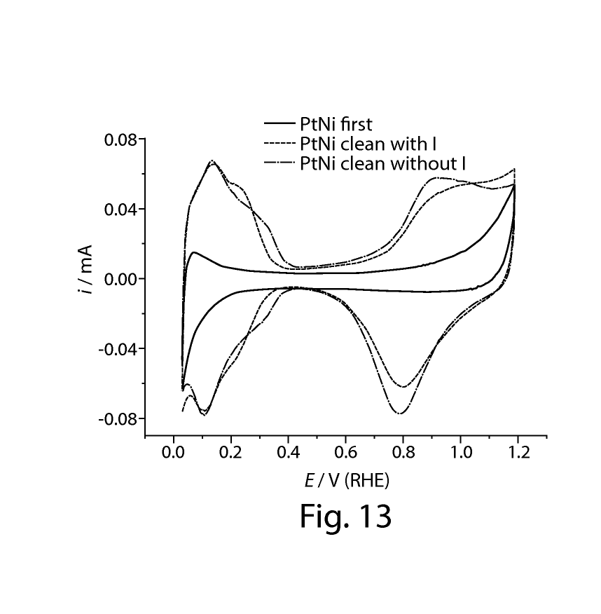

The iodine adsorbed on the surface of PtNi(I) nanoparticles could be removed. This allowed the unambiguous comparison of the effect of the iodine on the electrochemical properties of the nanoparticles. FIG. 12 shows the CV plot over 20 cycles of PtNi(I) nanoparticles during CO oxidation (to remove the adsorbed I on the surface, top), and a CV plot of PtNi nanoparticles with no I adsorbed on its surface (bottom). After removal of the iodine, the electrochemical properties were compared. FIG. 13 shows an overlay of CV plots of PtNi nanoparticles as synthesized (inner curve), PtNi(I) after washing with HNO₃ to enrich Pt on the surface (middle curve), and PtNi after HNO₃ wash and removal of all I on the surface (outer curve).

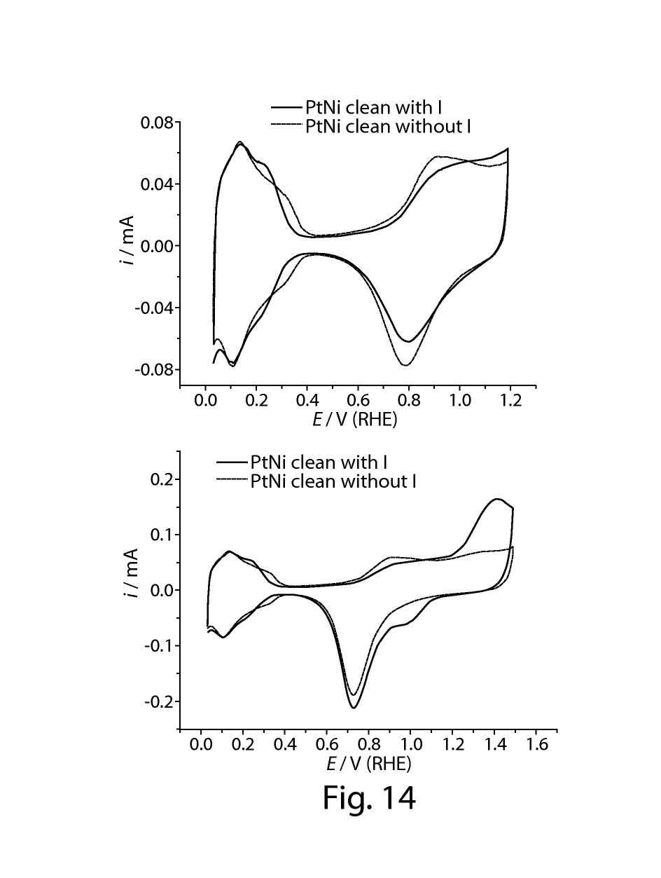

FIG. 14 shows overlays of CV plots comparing a PtNi(I) sample vs. PtNi (i.e. a PtNi nanoparticle with adsorbed I vs. the same sample with no adsorbed I) to determine the percentage of the surface covered by adsorbed I. In the overlay plot for a first sample, shown in the top illustration, the S_{I}/S_{no-I}=1.213/1.276=95.06%, or about 5% I coverage. In the overlay plot for a second sample, shown in the bottom illustration, the S_{I}/S_{no-I}=1.289/1.345=95.84%, or about 4.2% I coverage.

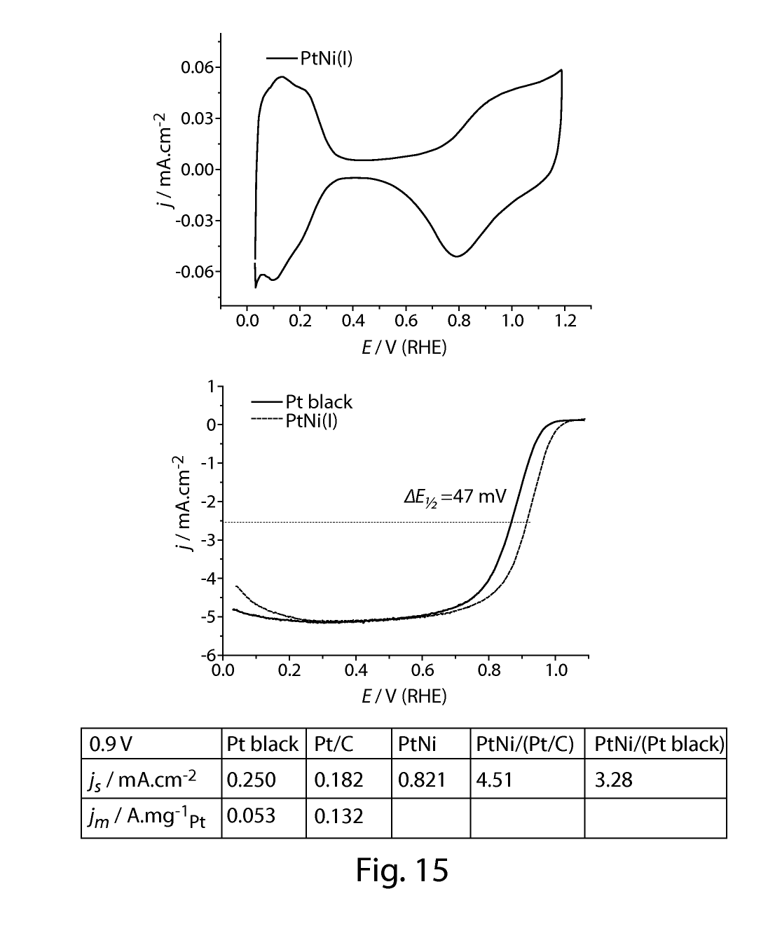

The ORR activity and durability of the PtNi(I) nanoparticles was next examined. FIG. 15 shows a normal CV plot of initial PtNi(I) nanoparticles (top) and a corresponding ORR polarization curve comparing the initial graphs of Pt black vs. PtNi(I) (bottom). The PtNi(I) material displays a ΔE_{1/2}of +47 mV relative to Pt black.

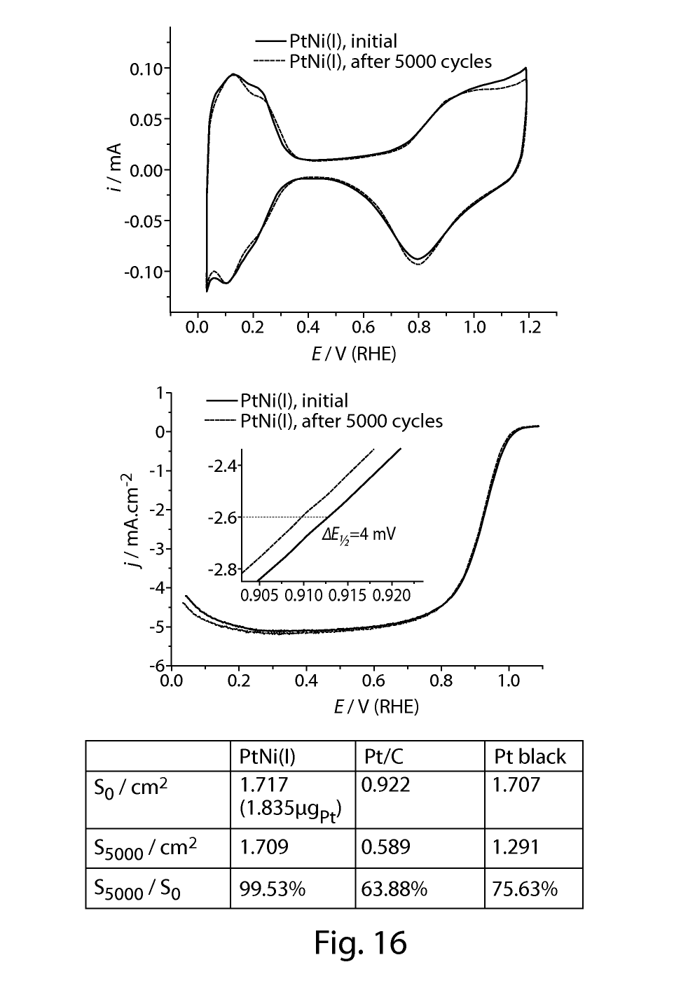

The durability of the PtNi(I) nanoparticles was impressive. FIG. 16 shows a CV plot of PtNi(I) and that after 5,000 cycles (top) and ORR polarization curves of initial and post-5,000 cycles (bottom). The ΔE(5000)_{1/2} is only −4 mV.

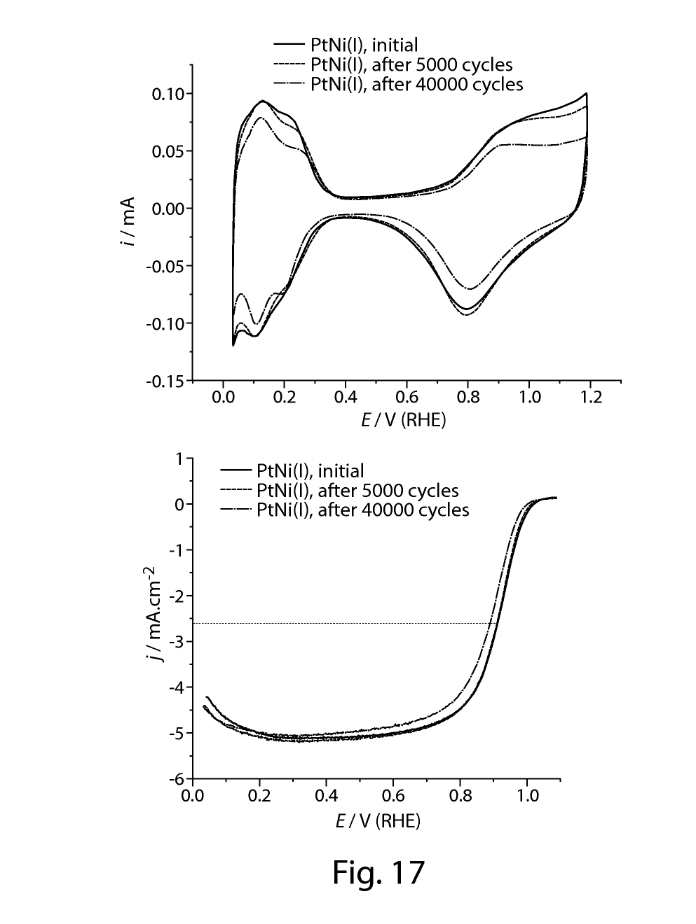

FIG. 17 shows an overlay of CV plots (top illustration) of PtNi(I) nanoparticles for initial (outermost curve), 5,000 cycles (middle curve), and 40,000 cycles (inside curve) and polarization curves (bottom illustration) for initial (rightmost curve), 5,000 cycles (middle curve), and 40,000 cycles (leftmost curve). The surface areas are as follows: S₀=1.717 cm²; S₅₀₀₀=1.709 cm² (99.53% S₀); S₄₀₀₀₀=1.411 cm² (82.18% S₀). The ΔE(5000)_{1/2}=−4 mV, and ΔE(40000)_{1/2}=−24 mV.

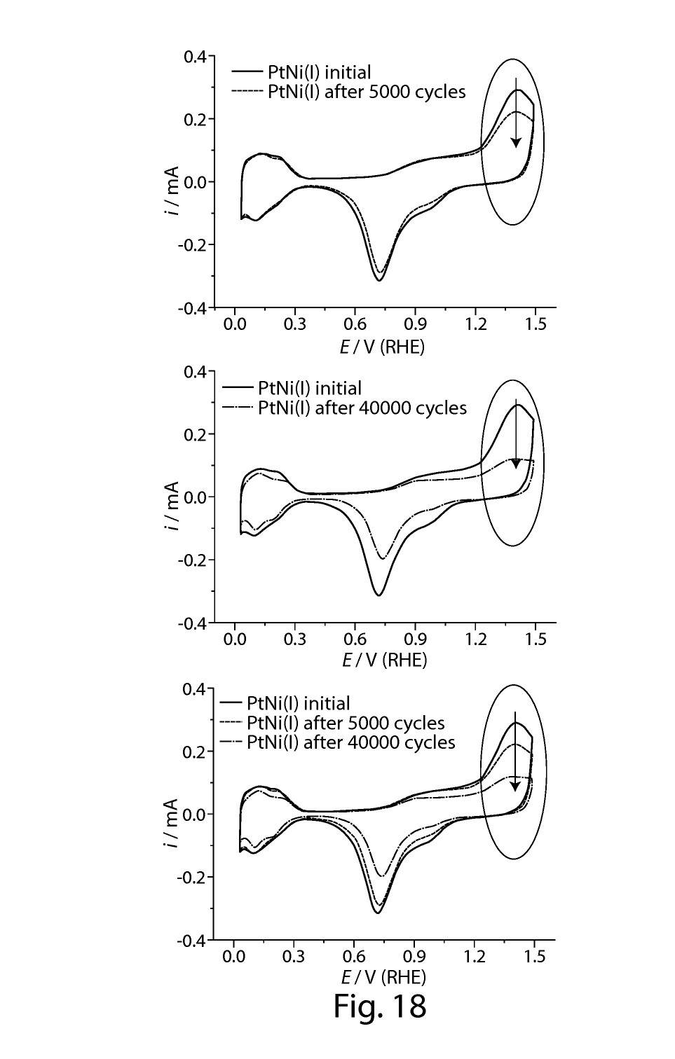

The adsorbed iodine gradually disappeared over the course of the PNi(I) durability test. FIG. 18 shows an overlay of CV plots depicting the disappearance of the I⁻ oxidation peak over the course of time. The plots compare the CV curves of 0, 5,000, and 40,000 cycles.

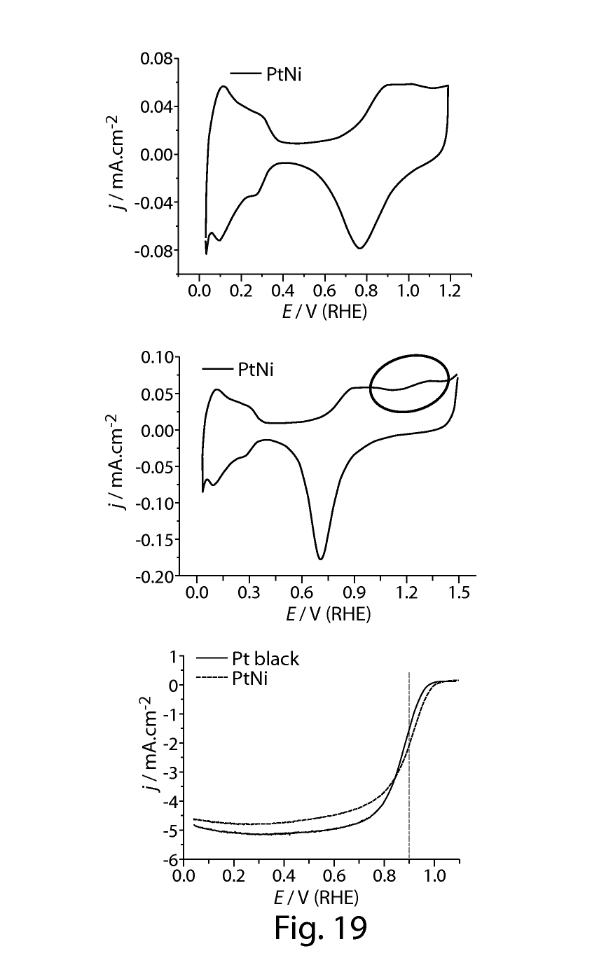

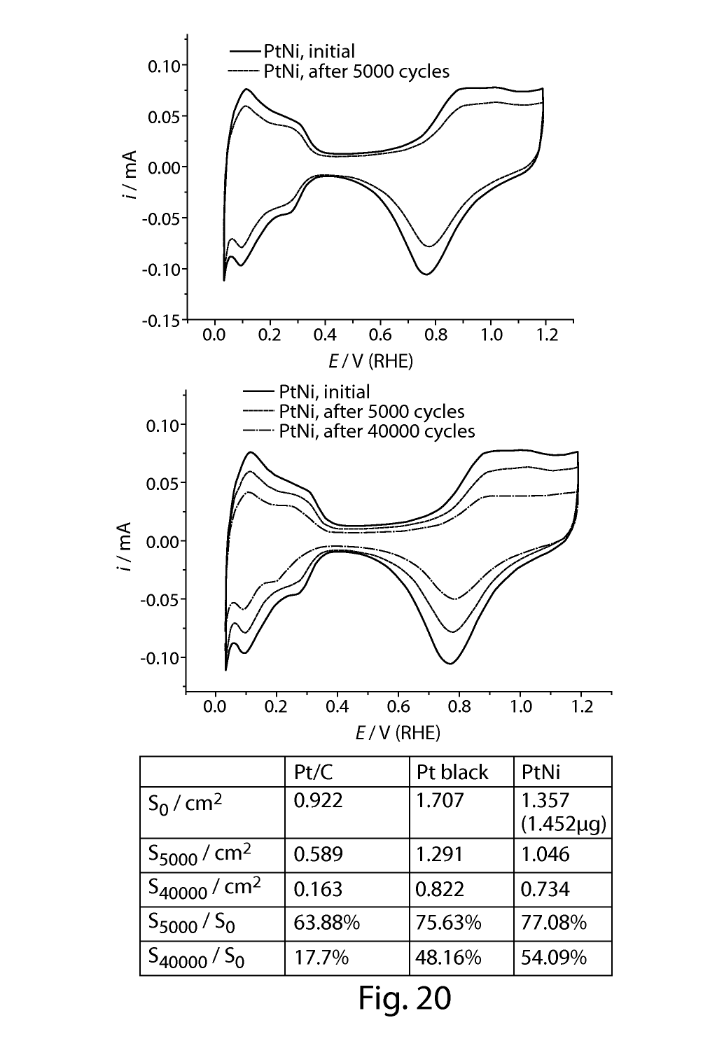

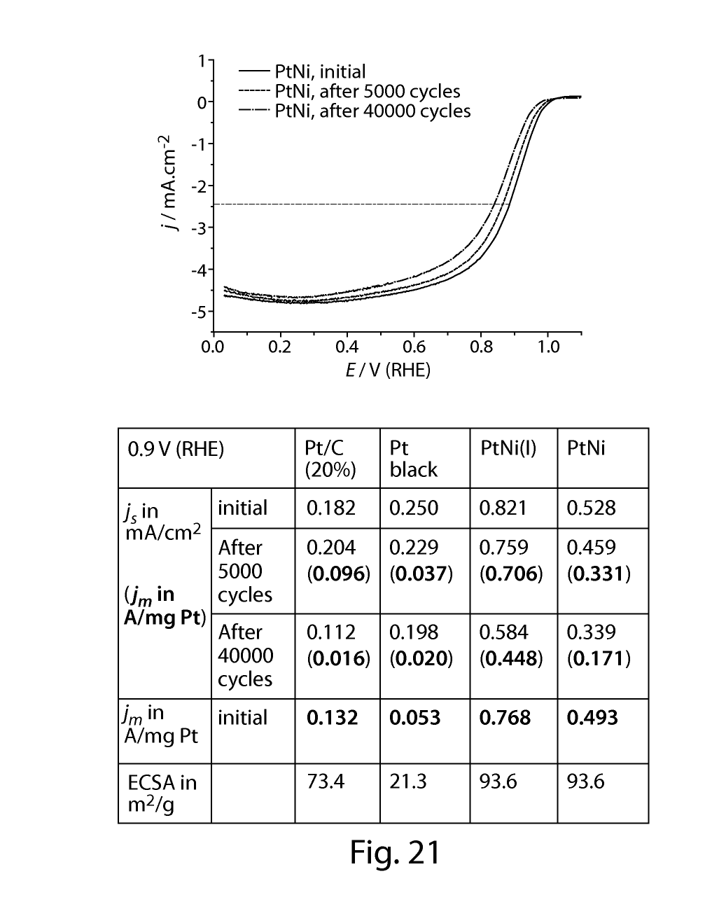

Next, nanoparticles lacking adsorbed iodine were tested. FIG. 19 shows two CV plots of PtNi samples containing a trace or no adsorbed iodine (top) and the overlaid polarization curves of Pt black and PtNi with no iodine (bottom). The jₛ of the PtNi was 0.528 mA/cm² vs. 0.250 for Pt black at 0.9 V. FIG. 20 shows overlays of normal CV plots depicting electrochemical surface area of PtNi material containing a trace or no absorbed iodine of 0 vs. post-5,000 cycles (top) and 0 vs. post-5,000 vs. post-40,000 cycles (bottom). In the bottom overlay, 0 cycles corresponds to the overmost curve, 5,000 cycles corresponds to the middle curve, and 40,000 cycles corresponds to the innermost curve. FIG. 21 shows an overlay of ORR polarization curves of PtNi material containing a trace or no adsorbed iodine for initial (rightmost curve), post-5,000 cycles (middle curve), and post-40,000 cycles (leftmost curve).

### Example 5

Electrochemical Properties of PtCu Nanoparticles Containing Adsorbed Iodine Atoms

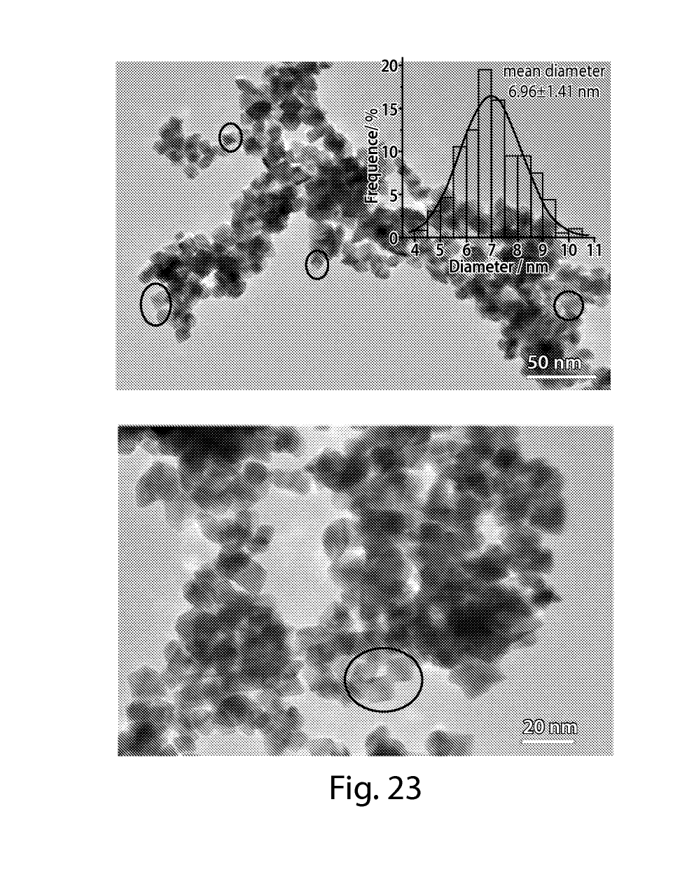

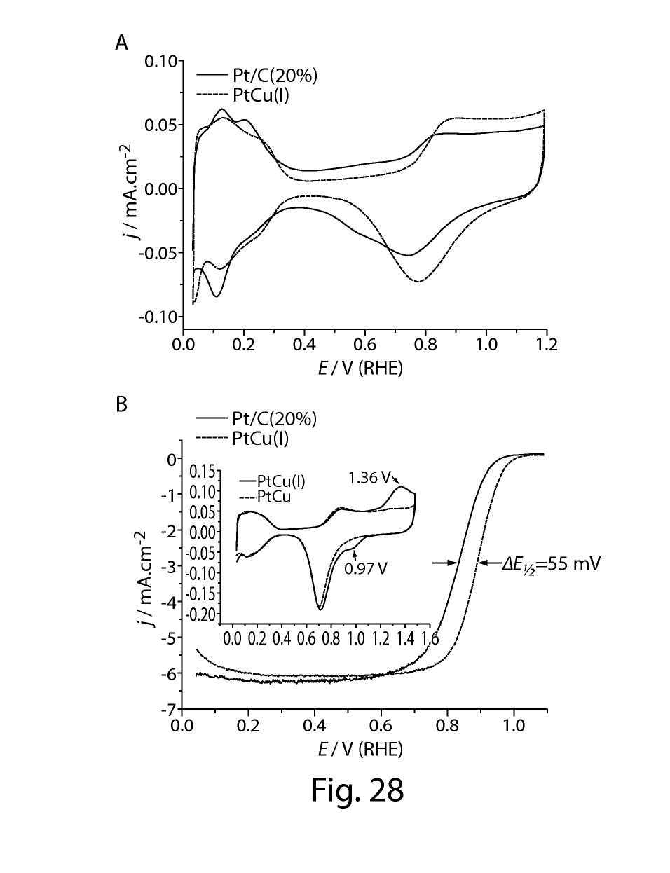

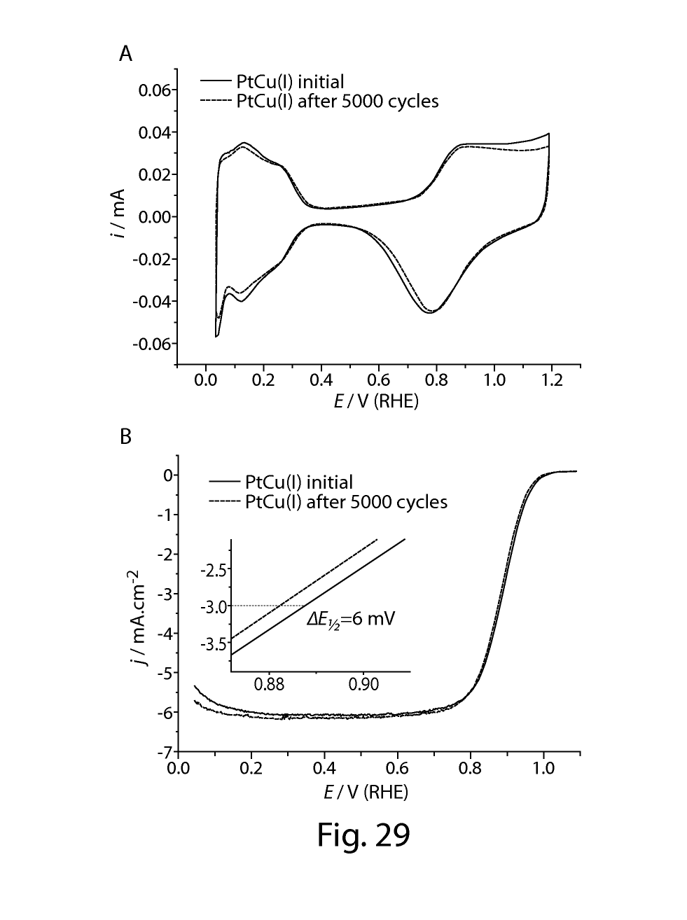

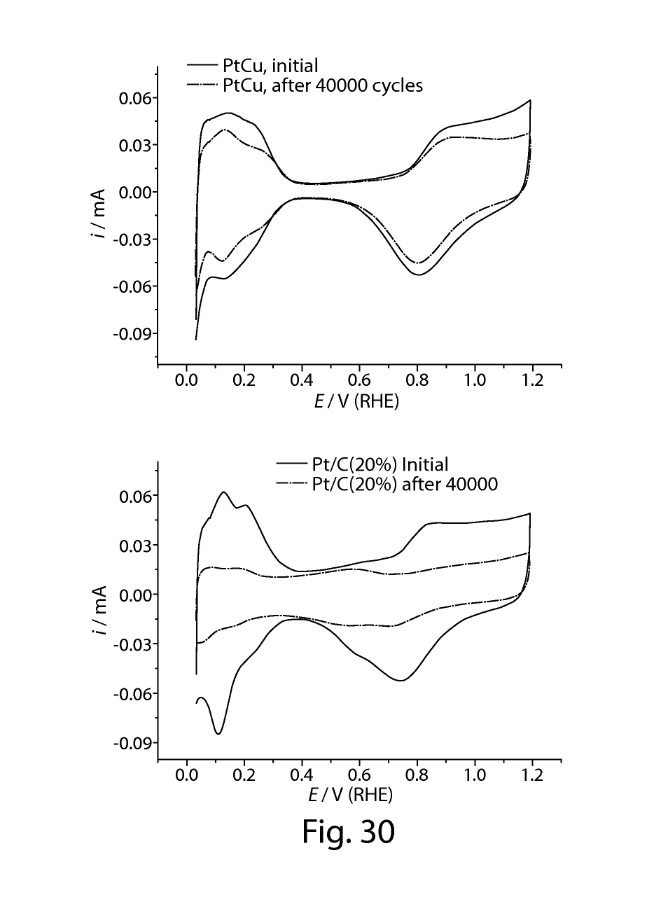

As described in Example 1, 7 nm PtCu (stoichiometry 1:1) alloyed nanoparticles containing adsorbed iodine (hereinafter abbreviated PtCu(I)) were prepared by a hydrothermal method in the presence of NaI (see FIGS. 22 and 23; the XRD spectrum confirms that the NPs synthesized were indeed PtCu(I) alloyed NPs) and discovered unexpectedly that they not only possess superior ORR activity (FIG. 28B) but also have higher stability (FIGS. 29 and 30).

FIG. 28 compares (top) the normal CVs and (bottom) rotating disk (1600 rpm) ORR polarization curves between commercial Johnson-Matthey Pt/C (20 wt % Pt loading) and the PtCu(I) alloyed nanoparticles. Remarkably, the PtCu(I) alloyed nanoparticles show a positive shift of 55 mV in the half-wave potential as compared to that of Pt/C, which leads to a 7-fold increase in specific kinetic current measured at 0.9 V (vs. RHE). As clearly shown by the oxidation peak at 1.36 V in the inset of FIG. 28 (bottom), there is adsorbed iodine on the PtCu(I) alloyed nanoparticles which plays a critical role in stabilizing them.

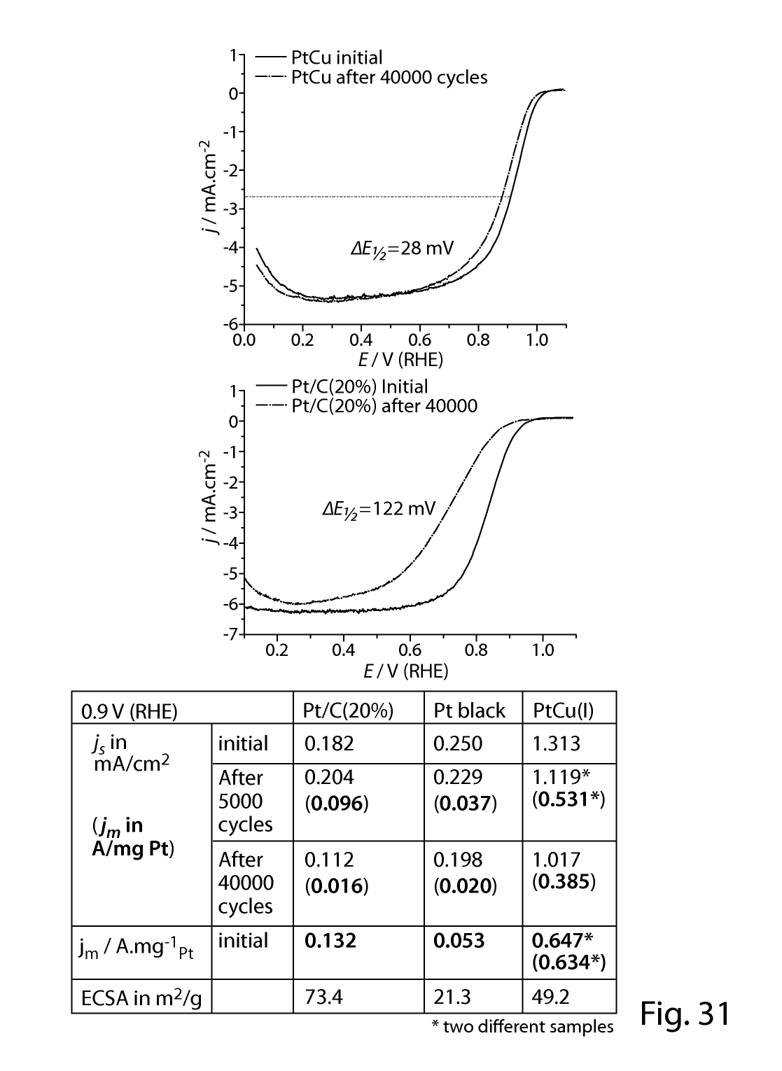

FIG. 29 shows the results of an accelerated stability test of the PtCu(I) alloyed nanoparticles. The stability was highly impressive: the loss in EASA was less than 4% and the negative shift of the half-wave potential was merely 6 mV (13% decrease in specific kinetic current at 0.9 V) after having been subjected to 5000 cycles of accelerated stability test. In contrast, Pt/C (20%) suffered a 36% loss in EASA and an 18 mV negative shift in half-wave potential (see FIGS. 1-3). As shown in FIGS. 30 and 31, PtCu(I) performs very well in an accelerated durability test. The loss in ECSA was less than 4% and the negative shift of the half-wave potential was merely 6 mV (13% decrease in specific kinetic current at 0.9 V) after having been subjected to 5,000 cycles of accelerated stability test.

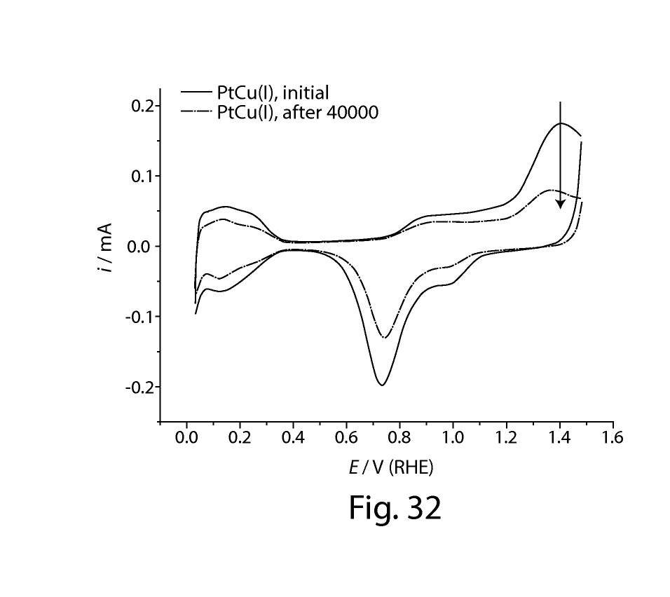

FIG. 30 shows an overlay of CV plots (top) of PtCu(I) nanoparticles for initial (outer curve) and post-40,000 cycles (inside curve) and an overlay of CV curves (bottom) of Pt/C (20%) for initial (outer curve) and post-40,000 cycles (inner curve). The surface areas (ECSA) are as follows: for PtCu(I), S₀=0.939 cm²; S₄₀₀₀₀=0.717 cm² (76.36% S₀). For Pt/C, S₀=0.922 cm²; S₄₀₀₀₀=0.163 cm² (17.7% S₀). FIG. 31 shows the polarization curves (top) of PtCu(I) initial vs. PtCu(I) after being subjected to the durability test for 40,000 cycles; the polarization curves (middle) of Pt/C (20%) initial vs. Pt/C after being subjected to the durability test for 40,000 cycles; and a table (bottom) of the electrochemical properties of PtCu(I) compared with Pt/C (20%) and Pt black. FIG. 32 shows an overlay of CV plots demonstrating that for PtCu(I) nanoparticles the peak at 1.36 V from the oxidation of surface iodine atoms disappears over time during the durability test.

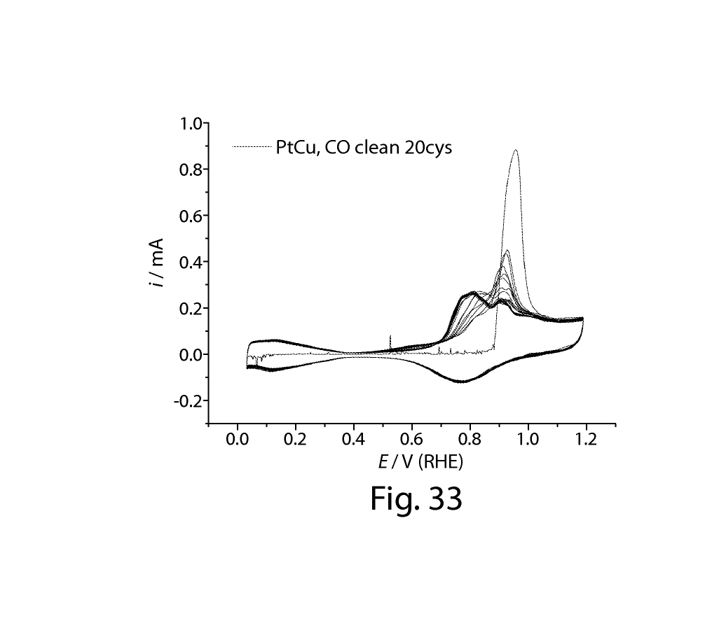

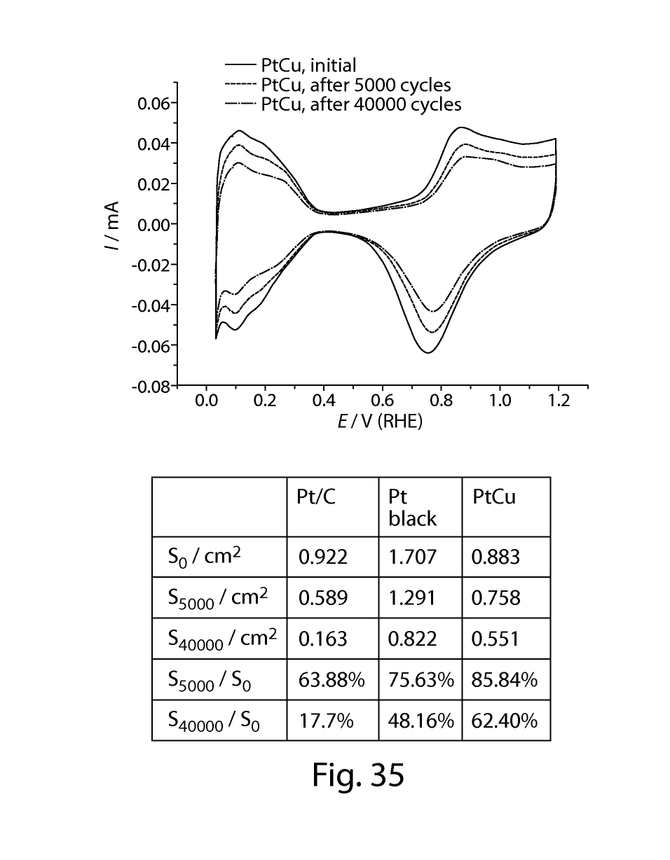

When the adsorbed iodine was removed by oxidation (FIG. 33), the stability of the PtCu alloyed decreased significantly: after 5,000 cycles of accelerated stability test, the EASA saw a 14% decrease and the negative shift of the half-wave potential was 40 mV (FIG. 35), which demonstrates the key stabilizing effect of adsorbed iodine. The adsorbed iodine atoms were removed by treatment with H₂O₂ combined with UV irradiation for 2 h. Fresh H₂O₂ aqueous solution (1.5 mL) was added every 15 minutes.

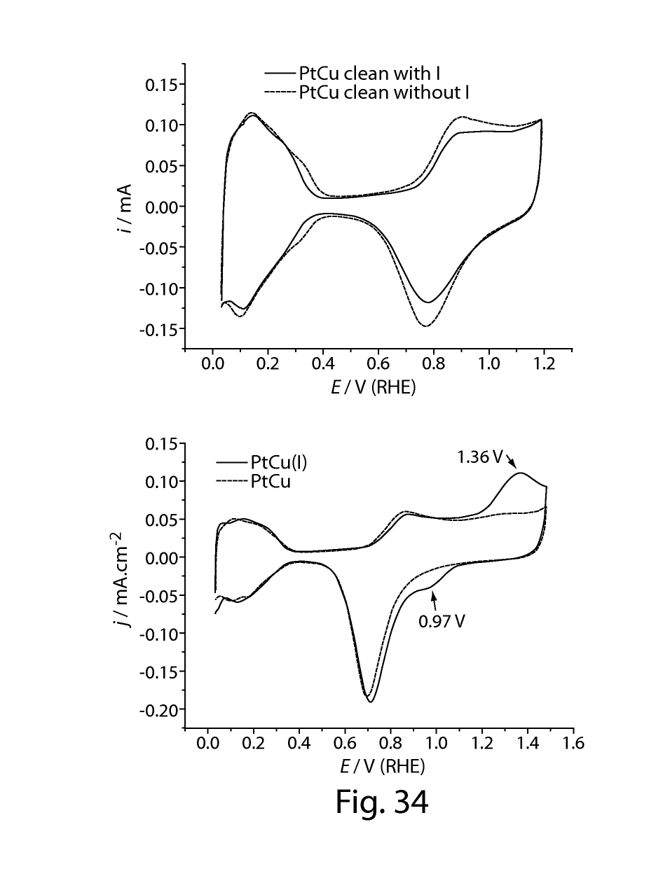

FIG. 34 shows an overlay of CV plots (top) comparing PtCu(I) vs. PtCu without adsorbed iodine and an overlay of alternate CV plots (bottom) comparing PtCu(I) vs. PtCu without adsorbed iodine. These comparisons allow the calculation of the coverage of the surface by the adsorbed iodine. The S_{I}/S₀=2.261/2.376=95.16%, or about 4.8% I coverage, for the top illustration. CV results indicate two I⁻ peaks disappeared, which means there is no iodine on the PtCu surface after UV/H₂O₂ treatment.

FIG. 35 shows an overlay of normal CV plots (top) of PtCu nanoparticles lacking adsorbed iodine atoms after 0 (outermost curve), 5,000 (middle curve), and 40,000 (innermost curve) cycles of durability testing and analysis of the surface area during the durability testing (bottom), with data for Pt/C (20%) and Pt black for comparison.

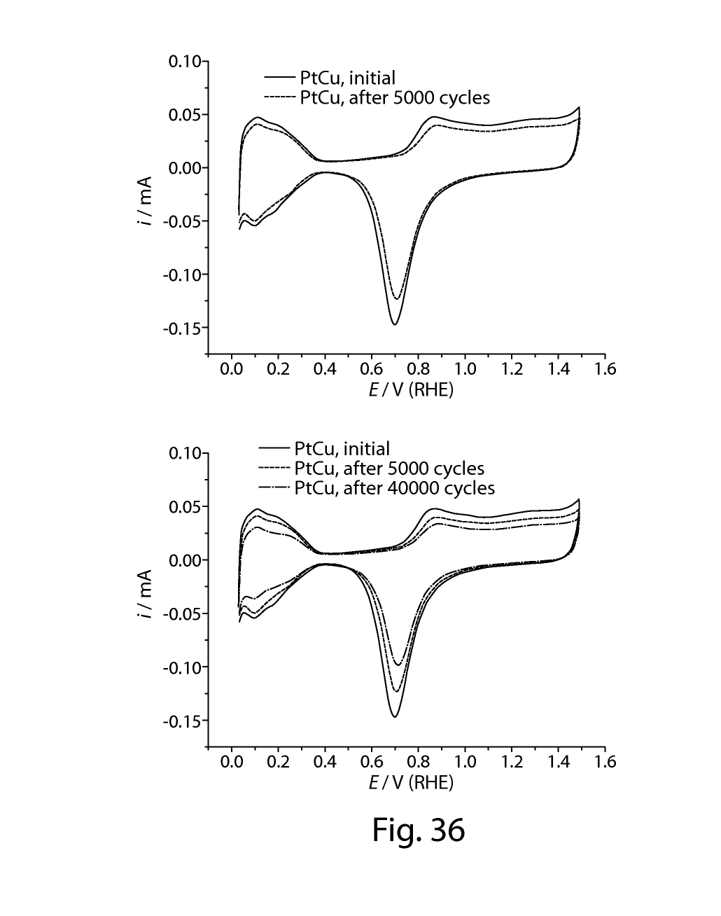

FIG. 36 shows an overlay of normal CV plots (top) of PtCu nanoparticles lacking adsorbed iodine atoms after 0 (outer curve) and 5,000 (inner curve) cycles of durability testing, and (bottom) an overlay of CV plots comparing 0 (outermost curve), post-5,000 (middle curve), and post-40,000 (innermost curve) cycles of durability testing.

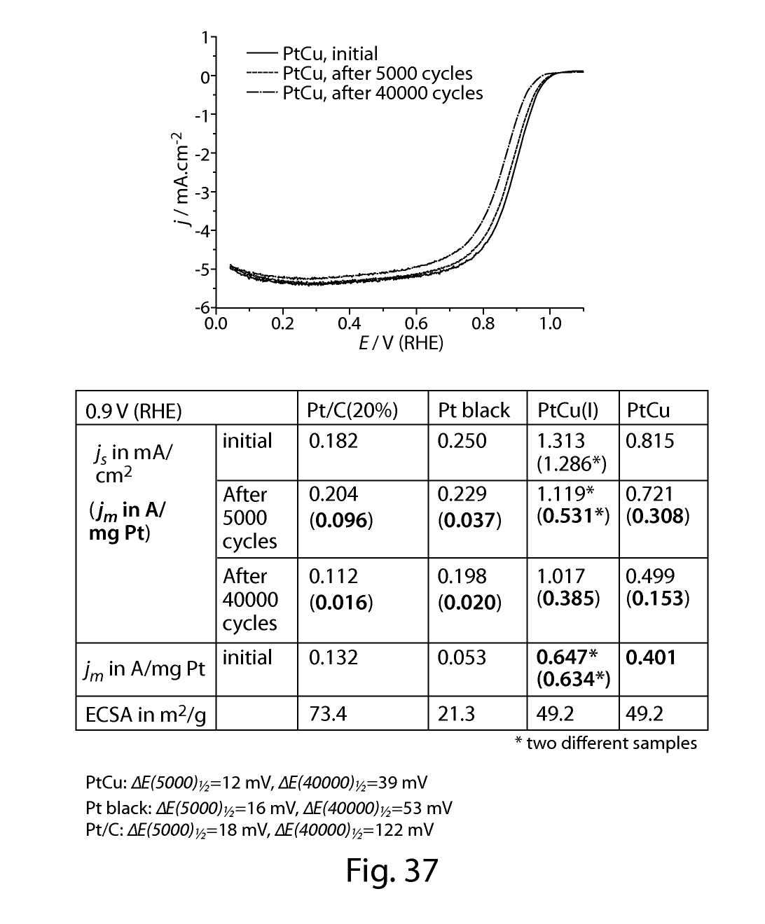

FIG. 37 shows an overlay of polarization curves (top) of PtCu nanoparticles lacking adsorbed iodine atoms after 0 (rightmost curve), 5,000 (middle curve), and 40,000 (leftmost curve) cycles of durability testing, and (bottom) data for the loss of surface area over the course of durability testing.

### Example 6

### Enhanced MOR Activity of PtCu(I) Nanoparticles

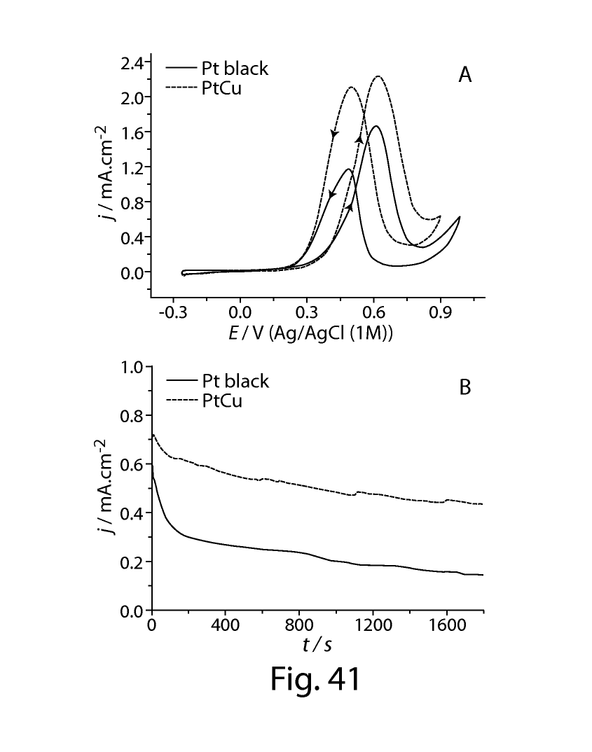

The PtCu(I) alloyed nanoparticles not only enhance ORR but also MOR. As shown in FIG. 41, the PtCu alloyed NPs with adsorbed iodine not only show ˜1.4 times larger CV peak current (intrinsic activity) but also ˜3.4 times larger CA (at 0.4 V) current (CO tolerance) of MOR (in 0.1 M HClO₄+0.5 M MeOH), which implies that they may have very different enhancement mechanism as compared to that of a PtRu system since the latter shows much smaller MOR CV peak current as compared to pure Pt but is still best CO-tolerant MOR catalyst (i.e., highest CA current).

### Example 7

### Enhanced Sulfide Tolerance of Nanoparticles Containing Adsorbed Iodine

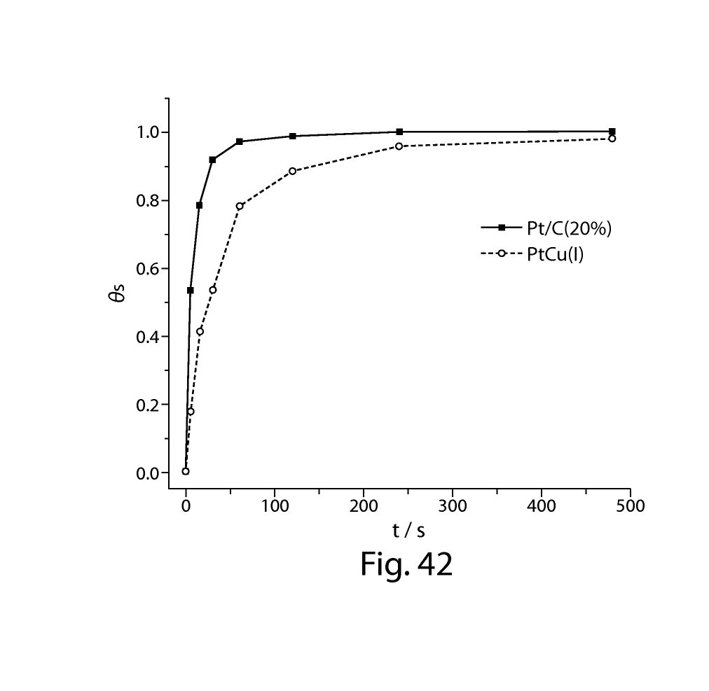

FIG. 42 compares the sulfide adsorption isotherms for Pt/C and PtCu alloyed NPs with adsorbed iodine. As can be clearly seen, the PtCu alloyed NPs demonstrates a much slower sulfide uptake, suggesting a better sulfur-poisoning tolerance.

Overall, as the above preliminary results obtained on the PtCu(I) alloyed NPs convincingly show, which are also in great contrast to the available literature data, these PtCu(I) alloyed NPs possess many superior catalytic properties, such as higher ORR and MOR activities, impressive stability, and better sulfur-poisoning tolerance. It appears that adsorbed iodine plays an important role in all of these improved properties.

### Equivalents

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways within the scope and spirit of the invention.

1. A particle having a core/shell structure, comprising a core represented by M_{core}; a shell represented by Mₛₕₑₗₗ; and a plurality of adsorbed iodine atoms on the surface of Mₛₕₑₗₗ;
wherein
M_{core} comprises a metal alloy of formula PtM; M is selected from the group consisting of Mn, Fe, Co, Ni, Cu, Ru, Pd, Ag, and Au; and the ratio of Pt:M is about 1:5 to about 5:1;
Mₛₕₑₗₗ comprises one to five layers of Pt atoms alloyed with up to about 10% M atoms; and
said particle has a diameter from about 2 nm to about 12 nm.

2. The particle of claim 1, wherein greater than 0% to about 10% of the surface of the particle is covered by the adsorbed iodine atoms.

3. The particle of claim 1, wherein the adsorbed iodine atoms represent greater than 0% to about 10% of the particle by weight.

4-11. (canceled)

12. The particle of claim 1, wherein the metal alloy in M_{core} is selected from the group consisting of PtNi, PtCu, PtRu, and PtAg.

13-21. (canceled)

22. An aggregate, comprising a plurality of particles of claim 1.

23. The aggregate of claim 22, wherein the particles have an average diameter of about 6.0 to about 8.2 nm.

24. The aggregate of claim 22, wherein the particles have an average diameter of about 2.2 to about 3.6 nm.

25. The aggregate of claim 22, further comprising a solid support.

26. The aggregate of claim 25, wherein the solid support is selected from the group consisting of activated carbon, carbon black, carbon cloth, carbon fiber paper, carbon nanotubes, carbon fibers, graphite, and a polymer.

27. A membrane electrode assembly (MEA) for a fuel cell, comprising an ion exchange membrane; and a catalyst layer comprising an aggregate according to claim 22.

28. The MEA of claim 27, further comprising a gas diffusion layer associated with the catalyst layer.

29. The MEA of claim 27, wherein the ion exchange membrane is a proton exchange membrane.

30. The MEA of claim 27, further comprising bi-polar plates for the introduction of gaseous reactants and coolants and the harvesting of electrical current.

31. The MEA of claim 27, wherein the MEA is a catalyst in an oxygen reduction reaction.

32. The MEA of claim 27, further comprising a source of O₂.

33. (canceled)

34. The MEA of claim 27, wherein the MEA is a catalyst in a methanol oxidation reaction.

35. (canceled)

36. (canceled)

37. A method of preparing a particle according to claim 1, comprising the steps of:
(i) providing a first compound comprising Pt; a second compound comprising a metal selected from the group consisting of Mn, Fe, Co, Ni, Cu, Ru, Pd, Ag, and Au; and a third compound comprising iodine or iodide;
(ii) combining the first compound, the second compound, and the third compound, thereby forming a crude product; and
(iii) washing the crude product with a solution comprising an acid, thereby forming the particle or aggregate.

38-41. (canceled)

42. The method of claim 37, wherein step (i) further comprises providing a reducing agent.

43. The method of claim 42, wherein the reducing agent is selected from the group consisting of lithium borohydride, sodium borohydride, potassium borohydride, and formaldehyde.

44-58. (canceled)

59. An electrode for an electrochemical cell, wherein the electrode comprises an aggregate according to claim 22.
